(19) United States
(12) Patent Application Publication
(10) Pub. No.: US 2010/0290857 A1
(43) Pub. Date: Nov. 18, 2010

(54) ELASTIC JOINT ELEMENT AND FASTENER ASSEMBLY INCORPORATING THE SAME

(75) Inventors: Hanna Maria SMOLAREK, Carine (AU); Gheorghe Emil Duta, Kallaroo (AU); David Liwszyc, Noranda (AU)

Correspondence Address: BURR & BROWN, PO BOX 7068, SYRACUSE, NY, 13261-7068, US

(73) Assignee: IQ FASTENERS PTY LTD., Canningvale (AU)

(21) Appl. No.: 12/766,407

(22) Filed: Apr. 23, 2010

Related U.S. Application Data
(63) Continuation of application No. 10/563,039, filed on Jun. 19, 2006, now abandoned.

(30) Foreign Application Priority Data
Jul. 1, 2003 (AU) 2003903340

(51) Int. Cl. F16B 31/00

(52) U.S. Cl. 411/14.5; 411/313

(57) ABSTRACT

A fastener assembly for use in a joint in a work-piece comprises a first fastener component for extending through a hole in the work-piece, a second fastener component and a resilient element. The first component has a first contact portion for engaging the work-piece. The second fastener component has a second contact portion for cooperating with the first fastener component to compressively load the work-piece thereby forming the joint. The resilient element is located between the first and second contact portions so that it is it is compressed under load. The resilient element has a first stiffness characteristic when subjected to loading less than a predefined amount and has a higher stiffness characteristic when subjected to loading more than the predefined amount.

### CROSS-REFERENCE TO RELATED APPLICATION

This application is a continuation application of U.S. application Ser. No. 10/563,039 (371(c) date of Jun. 19, 2006), which is a National Stage Application of PCT/AU2004/000898, filed Jul. 1, 2004, and claims the benefit of Australian Patent Application No. 2003903340, filed Jul. 1, 2003, the entireties of which are incorporated herein by reference.

### FIELD OF THE INVENTION

This invention relates to an elastic joint element for a fastener assembly for securing a work-piece in position. The invention also relates to a fastener assembly. The fastener assembly may be, but is not necessarily a threaded fastener.

### BACKGROUND OF TEE INVENTION

Figures A and B show a part sectional elevation of a typical joint 2001. Two joint components 2020, 2025 of a work-piece are clamped together by the co-operation of a threaded bolt 2005 and a threaded nut 2015. A sleeve 2010 is provided between the joint component 2020 and the nut 2015. The sleeve 2010 need not have the relative height as shown. The sleeve may be for example one or more washers.

As the nut 2015 is screwed down onto the bolt 2005, the clamping force F_{c} on the joint components 2020, 2025 will increase. The clamping force F_{C} is initially the pre-load force. That is, the force generated in the bolted joint as a result of initial tightening. As shown in figure B, a work load force F_{L} is applied externally to the joint components 2020, 2025 as the joint components 2020, 2025 are loaded. In figure B, the work load force F_{L} is shown as expansive such that the joint components 2020, 2025 are loading the joint system along the longitudinal direction of the bolt 2005.

Thus, the clamped components 2020, 2025 and the sleeve 2010 are in compression and the shank of the bolt 2005 is in tension. Immediately after the initial tightening to the pre-load clamping force, the bolt 2005 undergoes creep which causes the bolt 2005 to lengthen and the clamping force F_{C} to be reduced. Creep is also known as stress relaxation.

Figure C illustrates the clamping force F_{C} on a typical joint over the first 12 hours after initial lightening. As shown in figure C, substantially all the creep occurs in the first few hours after the joint assembly 2001 has been tightened. The clamping force F_{C} asymptotes towards a value which can be substantially lower than the pre-load clamping force. In figure C, the initial clamping force F_{C} (at time equals 0 hours) is 90 kN. Within 12 hours, the clamping force F_{C} is less than half the initial value (approximately 40 kN).

Creep (and stress relaxation) is proportional to the stress and temperature of the component. Therefore, at clamping forces F_{C} which approach the proof load (elastic limit) of the bolt 2005 the amount of creep will be significantly increased. This represents a significant problem in practice since maintaining a set clamping force F_{C} is highly desirable.

Therefore, to overcome the loss of clamping force F_{C} in a joint assembly such as that shown in figure A, the bolt 2005 and nut 2015 pair can be retensioned after the bolt 2005 has relaxed in order to return the clamping force F_{C} to the desired value. Alternatives include: selecting a bolt such that once creep has occurred the clamping force F_{C} is at the desired level, and/or selecting a bolt which, in the intended use, will experience a negligible amount of creep. Neither of these are satisfactory solutions since the result is inconvenience to the operator, potential damage to the clamped components in the joint, and/or over engineering of the joint assembly.

While the above discussion is directed to nut and bolt joint assemblies, it will be appreciated that the same issues are relevant for many types of fasteners.

There is a need for a fastener element which minimises the loss of clamping force resulting from creep in a fastener assembly when the fastener assembly applies a clamping force to a joint.

Furthermore, it would be advantageous for a fastener assembly in which the loss of such a clamping force is minimal when the initial clamping force is close to the lowest proof load of the components in the fastener assembly.

Is

Upon application of the work load, elasticity of the clamping part of the joint much larger than the elasticity of the clamped part, and has the effect of diminishing the total load in the clamped part. Only a small fraction of the work load is transferred to the clamping part including the bolt. A flattened elastic washer increases the stiffness of the clamping part of the joint and consequently increases the fraction of work load transferred to the clamping part of the joint. Preservation of the initial clamping force value allows larger work loads to be applied to the joint before failure through separation of the clamped components or failure of the bolt occurs.

Also, there have been numerous prior art proposals to render threaded fasteners resistant to unintentional unscrewing. Typically such proposals involve elements such as wedges, locking ratchets, elastic washers and elastic nuts, all of which have been previously described in prior art, part of them in an undeveloped form or function. The locking action is usually achieved through interaction between joint elements, and in some cases the work-piece. The interaction can be dynamic (as in the case of locking wedges), static (as in the case of prevailing torque fasteners) or elastic (as in the case of spring washers).

Wedges have been used for more than 100 years for prevention of vibration induced unscrewing. Elastic washers have been used for damping vibrations and dissipating the energy of shocks. Ratchets have been used for embedding in the clamped work-piece. However, none of the prior art proposals have been entirely effective in providing a controlled locking torque which prevents unintentional unscrewing of a threaded fastener assembly in service while allowing the assembled fastener to be intentionally unthreaded in a convenient manner.

Specifically, elastic elements of prior art (such as elastic washers) fail to withstand, without flattening (loosing elasticity), the heavy loads of critical applications where fasteners starting with ISO property class 8.8 bolts and class 8 nuts are used.

It is against this background, and the problems and difficulties associated therewith, that the present invention has been developed.

Additionally, the present invention proposes further improvements to solutions, disclosed in patent application PCT/AU01/00255, addressing failures of threaded fastener assemblies and extends its application to other mechanical joints.

It is to be understood that, if any prior art publication is referred to herein, such reference does not constitute an admission that the publication forms a part of the common general knowledge in the art, in Australia or any other country.

In the claims of this application and in the description of the invention, except where the context requires otherwise due to express language or necessary implication; the words “comprise” or variations such as “comprises” or “comprising” are used in an inclusive sense, i.e. to specify the presence of the stated features but not to preclude the presence or addition of further features in various embodiments of the invention.

### BRIEF DESCRIPTION OF THE INVENTION

According to one aspect of the invention there is provided an elastic joint element for a threaded fastener assembly, the elastic joint element comprising a body having a central axis, the body having first and second engaging faces between which the body can be subjected to compression upon tightening of the threaded fastener assembly, and a central hole extending through the body along the central axis, the body being elastically deformable when subjected to compression, characterised in that the elastic stiffness of the body increases during loading under compression once the body has undergone deflection beyond a predetermined extent.

Preferably, the change in stiffness occurs as a single step.

In a typical threaded fastener assembly involving a bolt and a nut in threaded engagement, the proof load of the bolt is less than that of the nut. Where the elastic element according to the invention is used in a threaded fastener assembly comprising a bolt and nut in threaded engagement, it is advantageous for the stiffness of the body to change at a predetermined clamping force so that the change in stiffness could be automatically, detected by an electronic control of assembly power tools. The same could be detected in case of manual tightening.

Preferably, the first engaging face is configured for engagement with a rotatable element of the threaded fastener assembly in a manner allowing rotation of the rotatable element in a tightening direction while inhibiting rotation of the rotatable element in the unscrewing direction. For this purpose, the first face may be equipped with a ramp structure for mating engagement with a complementary ramp structure on the rotatable element, the mating ramp structures cooperating to provide a ratchet mechanism allowing rotation of the rotatable element in the tightening direction while inhibiting rotation in the unscrewing direction.

The first engaging face may be flat in the sense that it occupies a plane substantially normal to the central axis of the elastic element, or it may be profiled in cross section such as frusto-conical or arcuate.

Where the first engaging face is profiled in cross-section, it is preferably inclined to a plane normal to the central axis of the elastic element at an angle of no more than about 15° to said plane.

It is advantageous to angle the face as it allows centering of the element in relation to the adjacent part of the assembly. The structure may be equipped with interposed ratchet ramps, each having a ramp face and ramp shoulder, a plurality of which makes up a ramp structure. If the elastic element is part of a threaded assembly, the ratchet ramps allow another member of the assembly being in contact therewith to move in, the tightening direction and to oppose movement in the unscrewing direction. Such feature in combination with resilient properties of the elastic element allow it behave as a clutch. Consequently, if a torque, bigger than that expected to occur during operation, such as for deliberately unscrewing, is applied to the member in contact with the elastic element (either directly or indirectly), in the unscrewing direction, the member will be riding on the ramp shoulder and dropping onto the adjacent ramps, ultimately releasing tension in the assembly. To allow such behaviour ramp shoulder need's to be inclined such that its pitch should be smaller than twenty times the pitch of the thread.

The elastic joint element may be constructed such a way that torque transferred through the engaging face during unscrewing is bigger than that transferred through the ramp structure. This can be assured through either constructing the engaging face of appropriate large diameter or through incorporation of ridges/protrusions on the engaging face that, embed into the work-piece.

The geometry of the elastic joint element allows it to withstand many times the forces which prior art resilient discs and washers can withstand, as specified in DIN 6796. Further, the elastic joint element features the changing stiffness characteristic. Such a characteristic, which is generally linear relationship of forces as a function of deflection, could incorporate a continuous rate of change of stiffness or could have certain inclination leading towards proof load of externally threaded element of the joint. Further loading beyond that value results in lesser elongation per unit force.

Means may be provided for reducing frictional resistance between the mating ramp structures during relative movement therebetween corresponding to tightening of the threaded fastener assembly. Such means may take any appropriate form, such as a lubricant therebetween or the provision of rollers facilitating relative movement therebetween at lower frictional resistance.

Preferably, the second engaging face is configured for engagement with a work-piece.

Preferably, the second engaging face includes a curved configuration. The curved configuration may involve concavity and a point of inflection at which the concavity reverses, the concavity being inwardly facing on the radially outer side of the point of inflection and outwardly facing on the radially inwardly side of the point of inflection.

The second engaging face preferably further includes a flat section and a further section radially inward of the flat section, the further section being of said curved configuration.

Preferably, the body further includes a flange portion extending inwardly to an inner periphery thereof extending around the central hole, the inner periphery being at a diameter smaller than the inner diameter of each of the engaging faces.

Preferably, the curved configuration of the second engaging face merges with the flange portion.

A further improvement is to enlarge the internal flange so it forms a cylinder with a face for supporting the excessive loading that might occur from time to time during operations as well, to establish a limit of preloading to be sensed during torquing operation

The body of the elastic element may be equipped with means for providing an indication of the extent of relative rotation between the rotatable element and the elastic element following initial engagement therebetween, which will indicate the amount of forces interposed on the joint during pre-loading. The indication may be of any appropriate form, such as a visual indication, an acoustic indication torque sensing or a combination thereof.

The advantage of incorporation of the supporting cylinder that allows sensing the appropriate preload is substantial as it also allows for precision retorquing back to the appropriate level after joint relaxation occurs and is the easiest from the operational point of view.

According to a second aspect of the invention there is provided a threaded fastener assembly incorporating an elastic element according to the first aspect of the invention.

In one arrangement, the elastic element comprises a washer. The washer and the adjacent component of the threaded fastener assembly with which the washer engages, preferably have mating surfaces profiled to provide an interface which acts to centrally align the component and the washer with respect to the central axis thereof.

According to a third aspect of the invention there is provided an elastic joint element comprising a body having a central axis including two opposed sides, an outer periphery, an inner periphery defining a central aperture, one opposed side being provided with a structure for interaction with an adjacent component of a joint assembly to provide a mechanical connection therebetween, the other opposed side defining a further engaging face including a curved configuration.

The curved configuration may involve concavity and a point of inflection at which the concavity reverses, the concavity being inwardly facing on the radially outerside of the point of inflection and outwardly facing on the radially inwardly side of the point of inflection.

The further engaging face preferably further includes a flat section and a further section radially inward of the flat section, the further section being of said curved configuration.

Preferably, the body further includes a flange portion extending inwardly to an inner periphery thereof extending around the central hole, the inner periphery being at a diameter smaller than the inner diameter of each of the engaging faces.

Preferably the internal flange forms a cylinder coaxial with the fastener's centre of rotation with a face for supporting the excessive loading that might occur from time to time during operations as well to establish a limit of preloading to be sensed during torquing operation.

Preferably, the curved configuration of the second engaging face merges with the flange portion or cylinder portion.

Preferably said opposed side provided with a structure for interaction with a component of a joint assembly to provide a mechanical connection therebetween, may be profiled in cross-section to accommodate the adjacent component. The profiling may be of any appropriate form; such as a taper.

According to a fourth aspect of the invention there is provided a threaded fastener assembly for releasably securing a work-piece in position, the threaded fastener assembly comprising a threaded fastener having an axis of rotation, an elastic element (such as an elastic washer) presenting an annular engaging face concentric with said axis of rotation for engaging the work-piece, means providing a mechanical connection between the threaded fastener and the elastic element facilitating rotation of the threaded fastener relative to the elastic element in a tightening direction while resisting relative rotation in a unscrewing direction, the threaded fastener comprising an assembly of first and second fastener members, the first fastener member comprising a head portion and a projection portion extending axially from the head portion, with an engaging face on the head portion surrounding the projection portion, the second fastener member comprising a first engaging face, a second engaging face and a central hole for receiving the projection portion of the first fastener member with a clearance fit and with the engaging face of the first fastener member in engagement with the first engaging face of the second fastener member, the second engaging face of the second fastener member being in engagement with the elastic element.

Preferably, the engaging face of the first fastener member and the first engaging face of the second fastener member are provided with a mechanical connection therebetween for coupling the first and second fastener members together for rotation in unison when the first fastener member is rotated in the tightening direction. The mechanical connection may, in one arrangement, also couple the first and second fastener members together for rotation in unison when the first fastener member is rotated in the unscrewing (unscrewing) direction. Alternatively, the mechanical connection may, in another arrangement, be adapted to urge the first and second fastener members axially apart in response to rotation of the first fastener member relative to the second fastener member in the unscrewing direction.

Where the mechanical connection couples the first and second fastener members together for rotation in unison when the first fastener member is rotated in the unscrewing (unscrewing) direction, the connection may be provided by any appropriate structure, such as for example inter-engaging grooves or the like, which provide a spline connection between the first and second fastener members.

Where the mechanical connection is adapted, to urge the first and second fastener members axially apart in response to rotation of the first fastener member relative to the second fastener member in the unscrewing direction, it may comprise a ramp structure on the second engaging face of the second fastener member and a complementary ramp structure on the elastic element, the mating ramp structures providing a ratchet mechanism allowing rotation of the first fastener member in the tightening direction while inhibiting rotation in the unscrewing direction.

Preferably, the mechanical connection between the first and second fastener members comprises a ramp structure on each of the engaging surfaces. With this arrangement, the ramp structures cooperate to provide a wedging action for wedging the first and second fastener members axially apart in response to rotation of the first fastener member, in the unscrewing direction. Typically, the wedges have a pitch greater than the pitch of threads of the threaded fastener, whereby rotation of the first fastener member in the unscrewing direction causes the threads to jam and consequently inhibit further rotation in the unscrewing direction.

The elastic nature of the elastic element allows it to undergo compression to provide freedom for the fastener assembly to be unthreaded without damage thereto.

The elastic element is preferably in accordance with the first aspect of the invention. The fastener may comprise a bolt or a nut.

Where the fastener is a nut, the hole therein for threadingly engaging a bolt extends through both the head portion and the projection portion, with the hole being internally threaded throughout the full length thereof. This arrangement provides for a nearly even load distribution along the threads in comparison to conventional nuts where the majority of the load is taken by the first few threads.

Preferably, the projection portion of the first fastener member is generally tapered inwardly towards the free end thereof, and the hole within the second fastener member is correspondingly shaped while also maintaining a clearance fit therebetween.

Preferably, the second engaging face of the second fastener member is larger than the first engaging face thereof. This is advantageous as it provides a larger area at the interface between the fastener and the elastic element to accommodate the ramp structure.

The face of the elastic element engaging the work-piece may be provided with means for inhibiting rotation of the elastic element relative to the work-piece. Such means may comprise one or more discrete embedding protrusions on the elastic element adapted to embed in the work-piece at low loads. Alternatively the engaging face may be of sufficiently large diameter that during operation creates the frictional torque larger than a torque transferred through the ramp structure. Each embedding protrusion may be defined by an integral tooth configured to embed in the work-piece. With this arrangement, the rotation of the fastener against the first face of the elastic element causes immediate embedment of the protrusions into the work-piece to prevent any relative movement between the elastic element and the work-piece which might otherwise cause the embedding portions to plough along the work-piece surface causing damage.

The threaded fastener assembly may be provided with means for providing a visual indication of the extent to which the threaded fastener assembly is preloaded. This may be achieved by way of a scale allowing the extent of rotation of the fastener relative to the elastic element to be determined after initial frictional contact therebetween. It is the extent of such rotation that determines the preload on the threaded fastener assembly.

Because of the ratchet engagement between the fastener and the elastic element, there is a “clicking” noise generated upon rotation of the fastener relative to the elastic element in the tightening direction after initial engagement therebetween. Such “clicking” noise can be utilised to regulate the extent of preload on the fastener assembly, as each “click” corresponds to a specific amount of angular rotation of the fastener and hence a specific incremental force imposed thereby. For example, in a particular fastener assembly it may be specified that tightening should be to a prescribed number of “clicks” in the assembly. In circumstances where it is difficult for a user to hear the “clicks”, a sound pick up device (such as an acoustic-electric transducer or microphonic device) may be employed. Such a device may incorporate amplification and/or control circuitry.

The threaded fastener assembly may be provided with torsional indication or the extent to which the threaded assembly is preloaded. This may be achieved through incorporation of the supporting structure such as the central cylinder that causes rapid change in stiffness easily sensed during preloading whether manual or with the use of power tools.

According to a fifth aspect of the invention there is provided a threaded fastener assembly for releasably securing a work-piece in position, the threaded fastener assembly comprising a threaded fastener having an axis of rotation, the threaded fastener presenting an annular engaging face concentric with said axis of rotation for engaging the work-piece or another component of the threaded fastener assembly, the threaded fastener comprising an assembly of first and second fastener members, the first fastener member comprising a head portion and a projection portion extending axially from the head portion, with an engaging face on the head portion surrounding the projection portion, the second fastener member comprising an engaging face and a central hole for receiving the projection portion of the first fastener member with a clearance fit and with the engaging face of the first fastener member in engagement with the engaging face of the second fastener member, said annular engaging face being provided on the second fastener member on the opposed side thereof the engaging face.

Preferably, the threaded fastener further comprises means providing a mechanical connection between the first and second fastener members for coupling them together for rotation in unison when the first fastener member is rotated in the tightening direction. The mechanical connection may, in one arrangement, also couple the first and second fastener, members together for rotation in unison when the first fastener member is rotated in the unscrewing (unscrewing) direction. Alternatively, the mechanical connection may, in another arrangement, be adapted to urge the first and second fastener members axially apart in response to rotation of the first fastener member relative to the second fastener member in the unscrewing direction.

Where the mechanical connection couples the first and second fastener members together for rotation in unison when the first fastener member is rotated in the unscrewing (unscrewing) direction, the connection may be provided by any appropriate structure, such as for example inter-engaging grooves or the like, which provide a spline connection between the first and second fastener members.

Where the mechanical connection is adapted to urge the first and second fastener members axially apart in response to rotation of the first fastener member relative to the second fastener member in the unscrewing direction, it may comprise a ramp structure on the second engaging face of the second fastener member and a complementary romp structure on the elastic element, the mating ramp structures providing a ratchet mechanism allowing rotation of the rotatable element first fastener member in the tightening direction while inhibiting rotation in the unscrewing direction.

The threaded fastener assembly according to the fourth and fifth aspects of the invention can each provide an elastic nut and washer assembly instead of the elastic joint element and which can also be a valuable proposition in combination with common, as well as new, elements of a threaded fastener assembly.

According to the invention there is provided a threaded fastener assembly for releasably securing a work-piece in position, the threaded fastener assembly comprising a threaded fastener, being a conventional nut or bolt, having an axis of rotation, the threaded fastener presenting an annular engaging face concentric with said axis of rotation for engaging an elastic element of the threaded fastener assembly, the second fastener member comprising an additional elastic element rotationally surrounding the chamfered portion of the conventional fastener allowing it to be self-centred on the first face of the second element as well as providing another elastic element integral with the rest of the second element arranged in series with the work-piece engaging flange and thereby increasing fastener's deflection.

The flange surrounding the chamfered portion of the conventional fastener can be equipped with ratchet teeth to prevent rotation of the threaded fastener in unscrewing direction or can be equipped with other means for preventing unscrewing.

Such an elastic nut and washer assembly is an important concept in fasteners as it could solve the problem of thread stripping and fatigue failure. The above failure modes result from overstressing sections of the thread that propagates once the stripping has been initiated. Axial loads, tend to increase the thread pitch of externally threaded fasteners with the corresponding decrease of pitch of the nut causing overloading of the first engaged threads. Building a nut with conical section that extends below its bearing surface converts it to partially tensile member with vastly improved load transfer. Such a fastener can withstand fluctuating loads other fasteners on the market cannot. Stress concentrations also occur at the head of the bolt. Adaptation of the elastic nut geometry to bolts and extending it further to other externally threaded parts will equally improve their performance. It is also beneficial to use a combination of an elastic nut and elastic bolt together within the same assembly.

Despite obvious advantages of the concept there are no elastic nuts or bolts on the market. Embodiments of this invention disclose a design that can be built and mass-produced. It proposes to split the known ‘concept nut’ into an elastic nut-washer assembly comprising parts that are mechanically locked. The locking mechanism might be of any appropriate form, such as grooves or ramps, for example, wedges and ratchets. Ratchets have been already described in conjunction with an elastic joint element. Wedges are formed in opposite to ratchets direction. Their shoulders engage during tightening process and ramp faces ride upon each other during unscrewing to wedge threads and dynamically lock them.

The central aperture of the washer follows the conical shape of the nut. The obvious advantage of such a form is a one-way fit, so there is no need for pre-assembly or gluing for proper installation. Another advantage is improved geometry that alleviates stresses.

All of the above-described elastic elements will combine their advantages when used together making common elastic joints. In fact a number of elastic elements can be assembled in series, parallel and their combination, very much as conventional conical washers are assembled to increase deflection or loading capability.

It is increasingly widely understood that locking system cannot compensate for under tensioned fasteners. Therefore embodiments of this invention discloses not only how to reliably lock fasteners but also how to accurately preload them and make them hold this tension while exposed to the most severe environmental, conditions like shocks, vibration and changing temperatures. One of such mechanisms is a scale and a pointer, as previously mentioned. They can be placed against each other on such parts that relatively rotate. Since forces in threaded assemblies are directly proportional to the angle of rotation it is sufficient to read the scale to be able to preload fasteners with accuracy far better than with the use of a torque range. The only tool required is a simple spanner.

Another method contemplated here is an acoustic device that picks-up the clicking noise generated during preloading by parts rotating on ratchets. There could be a vast number of possible devices that can be adopted, as referred to previously. Starting from the simplest amplifiers that help a fitter to count the clicks, to complex instruments that totalise clicks until preset loading is achieved.

A part common to all the disclosed assemblies is the elastic joint element functioning as a retainer washer that is in the immediate contact with a work-piece. For proper operation of the assembly, the retainer washer needs to have a sufficiently large diameter or other means that hold it in steady position. One such other means may comprise embedding protrusions, as referred to previously. Only few of such protrusions are necessary and they do not damage the opposite surface other than causing partly elastic indents, because they do not rotate against the work-piece surface, but are pushed in by other parts rotating on the washer.

This invention also contemplates use of multiple-start threads that can be utilised here to their best advantage since none of the proposed assemblies relies on thread's friction for holding it against unscrewing. With the use of friction reducing method a mechanical advantage can be the same with a much bigger thread pitch than used in present art fasteners assemblies.

To reduce friction on ratchets beyond a static friction, there may be use of roller bearings. Such roller bearings can be implemented in a number of different ways, some of which are described in more details iii further sections of this disclosure.

The use of an elastic element provides an elastic assembly that can hold an imposed pre-tension over a long operational life without retightening while not only standing up to but also accommodating to the most severe operational environment.

According to a sixth aspect of the invention, there is provided an elastic washer-fastener assembly as set forth herein which may be used either with or without additional washers.

According to the present invention there is provided a fastener comprising an elastically deflectable portion having a stiffness characteristic which changes when a load on the fastener is larger than a first load amount, the first load amount being smaller than a limit of elastic defection of the portion.

According to the present invention there is provided a fastener comprising a component having a load bearing surface for engaging an external surface of the an adjacent joint component, wherein the load bearing surface comprises a first contact section and a second contact section, wherein the fastener is resiliently deflectable such that the first contact section contacts the adjacent joint component through a first load amount range and the second load engaging section engages the adjacent joint component upon application of a load on the joint greater than the first load range.

According to the present invention there is provided a fastener comprising an elastic element and a through hole element, wherein the elastic element is adapted to withstand a proof load of the through hole element in an elastic manner with no or minimal plastic flow.

According to the present invention there is provided a joint comprising a fastener described above.

According to the present invention there is provided a joint comprising a work-piece having a through hole and a fastener comprising a component extending through the hole, wherein the fastener has a compact elastic element of an external diameter not exceeding three times nominal size of the fastener and a height not exceeding three quarters of the nominal size of the fastener, resiliently deflectable upon application of a load on the joint up to proof load of the fastener.

According to the present invention there is provided a fastener assembly for use in a joint in a work-piece comprising:

a first fastener component for extending through a hole in the work-piece, the first component having a first contact portion for engaging the work-piece;
a second fastener component having a second contact portion for co-operating with the first fastener component to compressively load the work-piece thereby forming the joint; and
a resilient element between the first and second contact portions so that it is compressed under load, the element having a resilience under a larger load range than either of the first and second fastener components.

According to the present invention there is provided a fastener assembly for use in a joint in a work-piece comprising:

a first fastener component for extending through a hole in the work-piece, the first component having a first contact portion for engaging the work-piece;
a second fastener component having a second contact portion for co-operating with the first fastener component to compressively load the work-piece thereby forming the joint; and
a resilient element between the first and second contact portions so that it is it is compressed under load; the element having a resilience under a proof load of the first fastener component.

According to the present invention there is provided a fastener assembly for use in a joint in a work-piece comprising:

a first fastener component for extending through a hole in the work-piece, the first component having a first contact portion for engaging the work-piece;
a second fastener component having a second contact portion for co-operating with the first fastener component to compressively load the work-piece thereby forming the joint; and
a resilient element between the first and second contact portions so that it is it is compressed under load, the element having a first stiffness characteristic when subjected to loading less than a predefined amount and having a higher stiffness characteristic when subjected to loading more than the predefined amount.

According to the present invention there is provided a fastener for use in a joint in a work-piece comprising:

a first fastener component for extending through a hole in the work-piece, the first component having a first contact portion for engaging the work-piece; and
a resilient element between the first contact portions and the work-piece so that it is compressed under load, the element having a resilience under a larger load range than the first fastener component.

According to the present invention there is provided a fastener assembly for use in a joint in a work-piece comprising:

a first fastener component for extending through a hole in the work-piece, the first component having a first contact portion for engaging the work-piece; and
a resilient element between the first contact portions and the work-piece so that it is it is compressed under load, the element having a resilience under a proof load of the first fastener component.

According to the present invention there is provided a fastener assembly for use in a joint in a work-piece comprising:

a first fastener component for extending through a hole in the work-piece, the first component having a first contact portion for engaging the work-piece; and
a resilient element between the first contact portions and the work-piece so that it is it is compressed under load, the element having a first stiffness characteristic when subjected to loading less than a predefined amount and having a higher stiffness characteristic when subjected to loading more than the predefined amount.

According to the present invention there is provided a fastener assembly for use in a joint comprising:

a fastener component having a load bearing surface;
a retaining washer having a first surface adapted to contact the load bearing surface of the fastener component and a second surface adapted to contact a work-piece, wherein the retaining washer is arranged to be resiliently compressible between its first and second surfaces,
wherein the load bearing surface of the fastener component and the first surface of the retaining washer are provided with a plurality of projections arranged to provide an acoustic indication of the rotation of the fastener component relative to the retaining washer.

According to the present invention there is provided a fastener assembly for use in a joint comprising:

a threaded fastener having a load bearing surface;
middle washer having a first surface adapted to contact load bearing surface and the second surface; and
a retaining washer having a first surface adapted to contact the second surface of the middle washer and a second surface adapted to contact a work-piece,
wherein the surfaces between the middle washer and the retaining washer are arranged to increase contact as compression between the threaded fastener and the work-piece increases.

According to the present invention there is provided a fastener assembly for use in a joint comprising:

a threaded fastener having a load bearing surface;
a middle washer having a first surface adapted to contact the load bearing surface and a second surface; and
a retaining washer having a first surface adapted to contact the second surface of the middle washer and a second surface adapted to contact a work-piece,
wherein the threaded fastener is arranged to transfer torque to the middle washer and the middle washer is arranged to rotate relative to the retaining washer,
wherein the retaining washer is arranged to remain static relative to the work-piece during tightening of the fastener.

According to the present invention there is provided a fastener assembly for use in a joint comprising:

a threaded fastener having a load bearing surface;
a middle washer having a first surface adapted to contact load bearing surface and the second surface; and
a retaining washer having a first surface adapted to contact the second surface of the middle washer and a second surface adapted to contact a work-piece,
wherein the threaded fastener comprises an external spline drive.

According to the present invention there is provided a fastener assembly for use in a joint comprising:

a threaded fastener having a load bearing surface;
middle washer having a first surface adapted to contact load bearing surface and the second surface; and
a retaining washer having a first surface adapted to contact the second surface of the middle washer and a second surface adapted to contact a work-piece;
a clutch means for resisting relative movement of the middle washer relative the retaining washer in an unscrewing direction;
a friction lowering means adapted to reduce the friction between the second surface of the first washer and the first surface of the retaining washer.

According to the present invention there is provided a fastener assembly comprising a compressible elastic portion and an elastically stretchable shank, wherein the elastic portion has a stiffness larger than the stiffness of the shank at a proof load of the shank.

According to the present invention there is provided a rivet comprising a shank portion and a head portion wherein at least part of the head portion is resiliently deflectable upon application of a load on the rivet up to a first load amount and upon application of a load to the rivet above the first load amount, wherein a stiffness characteristic of the head portion changes upon the load on the rivet being greater than the first load amount.

According to the present invention there is provided a rivet comprising a shank portion and a head portion, the head portion having a load bearing surface for engaging an external surface of the an adjacent component, wherein the load bearing surface comprises a first contact section, and a second contact section wherein part of the head portion of the rivet is resiliently deflectable such that the first contact section contacts the adjacent component upon application of a load on the rivet within a first load amount range, the second contact section engages the adjacent component upon application of a load on the rivet larger than the first load amount range.

According to the present invention there is provided a rivet comprising a shank portion and a head portion, the head portion having:

an annular flange extending from a longitudinal axis, the annular flange comprising a rim for contacting an adjacent component in a first longitudinal direction,
an annular depression positioned inwardly from the rim and
an annular projection around the longitudinal axis extending in the first direction less than the extension of the rim in the first direction when the rivet is in a relaxed state, the projection being positioned radially inwardly from the depression, wherein the shank portion extends in the first longitudinal direction from the annular projection,
wherein when the rivet is subjected to a longitudinal axial load, the rim of the annular flange can deflect in a second longitudinal direction.

According to the present invention there is provided a bolt comprising a threaded shank portion and a head portion wherein at least part of the head portion is resiliently deflectable upon application of a load on the bolt up to a first load amount and upon application of a load to the bolt above the first load amount, wherein a stiffness characteristic of the head portion changes upon the load on the bolt being greater than the first load amount.

According to the present invention there is provided a bolt comprising a threaded shaft portion and a head portion, the head portion having a load bearing surface for engaging an external surface of the an adjacent component, wherein the load bearing surface comprises a first contact section and a second contact section wherein part of the head portion of the bolt is resiliently deflectable such that the first contact section contacts the adjacent component upon application of a load on the bolt within a first load amount range, the second contact section engages the adjacent component upon application of a load on the bolt larger than the first load amount range.

According to the present invention there is provided a bolt comprising a threaded shank portion and a head portion, the head portion having:

an annular flange extending from a longitudinal axis, the annular flange comprising a rim for contacting an adjacent component in a first longitudinal direction,
an annular depression positioned inwardly from the rim and
an annular projection around the longitudinal axis extending in the first direction less than the extension of the rim in the first direction when the bolt is in a relaxed state, the projection being positioned inwardly from the depression and, the shank portion extends in the first longitudinal direction from the annular projection,
wherein when the bolt is subjected to a longitudinal axial load, the rim of the annular flange can deflect in a second longitudinal direction.

According to the present invention there is provided a washer comprising a resiliently deflectable portion, wherein the deflectable portion resiliently deflects upon application of a load on the washer up to a first load amount and upon application of a load to the washer above the first load amount, wherein a stiffness characteristic of the deflectable portion changes upon the load on the washer being greater than the first load amount.

According to the present invention there is provided a washer comprising an aperture and a load bearing surface for engaging an external surface of the an adjacent component, wherein the load bearing surface comprises a first contact section and a second contact section wherein part of the head portion of the washer is resiliently deflectable such that the first contact section contacts the adjacent component upon application of a load on the washer within a first load amount range, the second contact section engages the adjacent component upon application of a load on the washer larger than the first load amount range.

According to the present invention there is provided a washer comprising:

an annular flange extending from a longitudinal axis, the annular flange comprising a rim for contacting an adjacent component in a first longitudinal direction,
an annular depression positioned radially inwardly from the rim and
an annular projection around the longitudinal axis extending in the first direction less than the extension of the rim in the first direction when the washer is in a relaxed state, wherein, when the washer is subjected to a longitudinal axial load, the rim of the annular flange can deflect.

According to the present invention there is provided a washer for use in a joint comprising:

a first surface adapted to contact a first adjacent joint component, a second surface adapted to contact a second adjacent joint component and a curved flange,
wherein the retaining washer is elastically compressible between first and second surfaces and the second surface is formed on the flange,
wherein the retaining washer is substantially bell shaped in appearance.

According to the present invention there is provided a washer for use in a joint comprising:

a retaining washer having a load bearing surface and a second surface adapted to contact an adjacent joint component,
wherein the retaining washer includes a sleeve that contacts the adjacent joint component when compression between the load bearing surface and the adjacent joint component reaches a predetermined threshold.

According to the present invention there is provided a washer for use in a threaded fastener joint comprising:

a first load bearing surface for contacting a first joint element, the first load bearing surface being concave (conically or curved) shaped such that the first joint element tends to be self centred on the first load bearing surface;
a second opposite load bearing surface for contacting a second joint element; and
a central aperture extending between the surfaces comprising a socket portion and an inwardly projecting flange for receiving a sleeve portion of the first joint element.

According to the present invention there is provided a washer for use in a threaded fastener joint comprising:

a first load bearing surface for contacting a first joint element incorporating interlocking means for preventing rotational movement against the threaded fastener;
a second opposite load bearing surface for contacting a second joint element; and
a central aperture extending between the surfaces comprising a socket portion and an inwardly projecting flange for receiving a sleeve portion of the first joint element.

According to the present invention there is provided a washer for use in a threaded fastener joint comprising:

a plurality of ramps in a circular arrangement, the ramps collectively forming a load bearing surface;
a second opposite load bearing surface for contacting a second joint element; and
a central aperture extending between the surfaces comprising a socket portion and an inwardly projecting flange for receiving a sleeve portion of the first joint element.

According to the present invention there is provided a washer for use in a threaded fastener joint comprising:

a first load bearing surface for contacting a first joint element, the first load bearing surface being concave (conically or curved) shaped such that the first joint element tends to be self centred on the first load bearing surface; and
a second load bearing surface for contacting a second joint element,
wherein the washer is relatively rigid thereby retaining the concave shape under compression between the load bearing surfaces.

According to the present invention there is provided a retaining washer for use in a threaded fastener joint comprising:

a first surface adapted to contact a fastener element; and
a curved flange having a second surface adapted to contact a work-piece, wherein the retaining washer is resiliently compressible between the first surface and the second surface,
wherein the second surface is at a distal portion of the flange;
wherein the washer further comprises a sleeve portion positioned inwardly from the second surface, a base of the sleeve portion forming a third surface for contacting the work-piece upon compression of the flange.

According to the present invention there is provided a retaining washer for use in a threaded fastener joint comprising:

an elastic body having a first surface adapted to contact a fastener element and a second surface adapted to contact a work-piece;
wherein the elasticity of the body increases when compression increases.

According to the present invention there is provided a washer pair combination for use in a joint comprising:

a first washer having a first surface adapted to contact a load bearing surface of another fastener element and a second surface; and
a retaining washer comprising a first surface adapted to contact the second surface of the first washer and a second surface adapted to contact a work-piece,
wherein the second surface of the first washer is convex shaped and the first surface of the retaining washer is concave shaped such that the first washer tends to be self centred on the retaining washer,
wherein the first washer is relatively harder than the second washer.

According to the present invention there is provided a washer pair combination for use in a joint comprising:

a first washer having a first surface adapted to contact a load bearing surface of another fastener element and a second surface; and
an elastic retaining washer comprising a first surface adapted to contact the second surface of the first washer and a second surface adapted to contact a work-piece,
wherein the second surface of the first washer is convex shaped and the first surface of the retaining washer is concave shaped such that the first washer tends to be self centred on the retaining washer,
wherein the first washer is relatively non-elastic.

According to the present invention there is provided a washer pair combination for use in a joint comprising:

a first washer having a first surface adapted to contact a load bearing surface of another fastener element and a second surface; and
a resilient retaining washer comprising a first surface adapted to contact the second surface of the first washer and a second surface adapted to contact a work-piece,
wherein the second surface of the first washer comprises a plurality of protrusions and the first surface of the retaining washer comprises a plurality of complementary protrusions for resisting rotation of the first washer relative to the second washer in an unscrewing direction more than rotation in a tightening direction.

According to the present invention there is provided a washer pair combination for use in a joint comprising:

a first washer having a first surface adapted to contact a load bearing surface of another fastener element and a second convex shaped surface; and
a retaining washer comprising a first concave shaped surface adapted to contact the second surface of the first washer so that the first washer tends to centre itself on the retaining washer, the retaining washer further comprising a second surface adapted to contact a work-piece,
wherein the second surface of the first washer and the first surface of the retaining washer are arranged to increase surface contact with each other as the joint is tightened.

According to the present invention there is provided a washer pair combination for use in a joint comprising:

a first washer having a first surface adapted to contact a load bearing surface of another fastener element and a second convex shaped surface; and
a retaining washer comprising a first concave shaped surface adapted to contact the second surface of the first washer so that the first washer tends to centre itself on the retaining washer, the retaining washer further comprising a second surface adapted to contact a work-piece,
wherein the second surface of the second washer is arranged to increase surface contact with the work-piece as the joint is tightened.

According to the present invention there is provided a threaded fastener and washer combination for use in a joint comprising:

a threaded fastener comprising means for preventing rotation on a load bearing surface and a projecting sleeve portion tapering so as to narrow further away from the load bearing surface; and
a washer comprising a load bearing surface having a corresponding means to the means on the threaded fastener, the washer further comprising a socket for receiving the sleeve portion of the fastener.

According to the present invention there is provided a threaded fastener and washer combination for use in a joint comprising:

a threaded fastener comprising a plurality of ramps in a circular arrangement and a frusto-conical sleeve portion tapering so as to narrow further away from the load bearing surface; and
a washer comprising a plurality of ramps in a circular arrangement collectively forming a first surface adapted to contact the load bearing surface, the washer further comprising a socket for receiving the sleeve portion of the fastener.

According to the present invention there is provided a threaded fastener and washer combination for use in a joint comprising:

a threaded fastener comprising a first load bearing surface positioned at least one thread revolution inwardly from an axial end of the internally threaded fastener and radially spaced from the thread, the fastener further comprising a frusto-conical sleeve portion tapering so as to narrow further away from the load bearing surface; and
a washer comprising a first surface adapted to contact the load bearing surface, the washer further comprising a socket.

According to the present invention there is provided a threaded fastener and washer combination for use in a joint comprising:

a threaded fastener comprising a load bearing surface of convex shape; and
a washer comprising a first surface of concave shape adapted to contact the load bearing surface such that the fastener tends to centre itself on the washer, wherein the washer is relatively harder than the fastener.

According to the present invention there is provided a threaded fastener and washer combination for use in a joint comprising:

a threaded fastener comprising a load bearing surface of convex shape; and
a washer comprising a first surface of concave shape adapted to contact the load bearing surface such that the fastener tends to centre itself on the washer, the washer further comprising a plurality of projections in a circular arrangement collectively forming a second load bearing surface for cooperating with a joint element to provide greater resistance to relative movement in an unscrewing direction than movement in a tightening direction,
wherein the threaded fastener is resiliently deformable relative to the washer.

According to the present invention there is provided a fastener and washer combination for use in a joint comprising:

a threaded fastener comprising a convex shaped load bearing surface; and
a washer comprising a concave shaped first surface and resilient curved flange ending in a second surface adapted to contact a work-piece.

According to the present invention there is provided a fastener and washer combination for use in a joint comprising:

a threaded fastener having a load bearing surface; and
an elastic retaining washer having a first surface and a second surface adapted to contact a work-piece,
wherein the threaded fastener is arranged to rotate relative to the retaining washer, and
wherein the second surface of the retaining washer increases contact with a work-piece as the retaining washer is elastically deformed.

According to the present invention there is provided a fastener element comprising:

an annular flange extending from a longitudinal axis, the annular flange comprising a rim for contacting an adjacent component in a first longitudinal direction,
an annular depression positioned inwardly from the rim and
an annular projection around the longitudinal axis extending in the first direction less than the extension of the rim in the first direction when the fastener element is in a relaxed state, the projection being positioned inwardly from the depression,
wherein, when the fastening element is subjected to a longitudinal axial load, the rim of the annular flange can deflect in a second longitudinal direction.

According to the present invention there is provided a internally threaded fastener comprising:

a first load bearing surface positioned at least one thread revolution inwardly from an axial end of the internally threaded fastener and radially spaced from the thread; and
a frusto-conical sleeve portion tapering so as to narrow further away from the load bearing surface.

According to the present invention there is provided an externally threaded fastener for use in a joint comprising:

a head; and
an externally threaded shank extending from a first axial end of the head;
the head comprising a first load bearing surface positioned inwardly of the first axial end of the head and radially spaced from the shank; and a frusto-conical sleeve portion tapering so as to narrow further away from the load bearing surface, the external surface of the sleeve portion forming a second load bearing surface.

According to the present invention there is provided a threaded fastener for use in a joint comprising:

a plurality of ramps in a circular arrangement positioned at least one thread revolution inwardly from an axial end of the threaded fastener and radially spaced from the thread; and
a frusto-conical sleeve portion tapering so as to narrow further away from the ramps.

According to the present invention there is provided a threaded fastener for use in a joint comprising:

a plurality of ramps in a circular arrangement, the ramps collectively forming a load bearing surface, the ramps positioned at least one thread revolution inwardly from an axial end of the internally threaded fastener and radially spaced from the thread; and
a frusto-conical sleeve portion tapering so as to narrow further away from the load bearing surface, the external surface of the sleeve portion forming a second load bearing surface.

According to the present invention there is provided a method of loading a joint in a work-piece comprising a fastener to a desired load comprising:
providing a fastener having a means for determining the amount of loading in the joint;
detecting when the amount of load reaches the desired load;
wherein the means provides an indication of discrete increases in the load.

According to the present invention there is provided a method of loading a joint in a work-piece comprising a fastener to a predetermined load comprising:
providing a fastener having a means for changing the perceivable stiffness in the joint when the load in the joint reaches the predetermined amount;
   detecting when the amount of load reaches the desired load.

According to the present invention there is provided a threaded fastener assembly for releasably securing a work-piece in position, the threaded fastener assembly comprising a threaded fastener component and a second component, the threaded fastener component having an axis of rotation and presenting an annular engaging face concentric with said axis of rotation for engaging the elastic element, the threaded fastener component also having a chamfered portion surrounding the annular engaging face, the second component comprising a frusto-conically shaped flange for engaging the chamfered portion for allowing the threaded fastener component to be self-centred on a first face of the second component.

According to the present invention there is provided a washer for use in a fastener assembly for releasably securing a work-piece in position, the fastener assembly comprising a threaded fastener component having an axis of rotation and presenting an annular engaging face concentric with said axis of rotation for engaging the elastic element, the threaded fastener component also having a chamfered portion surrounding the annular engaging face, the washer comprising a frusto-conically shaped flange surrounding a load bearing face for engaging the chamfered portion for allowing the threaded fastener component to be self-centered on the load bearing face.

### BRIEF DESCRIPTION OF THE DRAWINGS

In order to provide a better understanding of the present invention, preferred embodiments will now be described, by way of example only, with reference to the accompanying drawings, in which:

Figure A is a schematic representation of a joint;

Figure B is a force analysis diagram of the joint of Figure A;

Figure C is a graph of compressive load force verses time;

FIG. 1 is a perspective view of an elastic joint element according to an embodiment of the present invention;

FIG. 2 is a schematic fragmentary view illustrating the configuration of a ramp structure providing ratchets on the elastic joint element;

FIG. 3 is a graph showing the load characteristics of the elastic joint element in terms of compressive force versus deflection;

FIGS. 3B and 3C are graphs showing load characteristics of an elastic fastener of FIG. 41;

FIG. 4 is a schematic cross-sectional view of the elastic joint element showing compressive deformation thereof at several stages of loading;

FIG. 5 is a detailed view of part of the elastic joint element illustrating its condition at said several stages of loading;

FIG. 6 is a cross-sectional view of the elastic joint element;

FIG. 7 is a partial cross-sectional view of the elastic joint element;

FIG. 8 is a partial cross-sectional view, showing an alternative configuration of an engaging face of the elastic joint element and parts of the profile of another engaging face of the elastic joint element;

FIG. 9 is a partial cross-sectional view, showing a further alternative configuration of an engaging face of the elastic joint element;

FIG. 10 is a perspective view of a threaded fastener assembly according to a second embodiment, the threaded fastener assembly comprising a nut assembly;

FIG. 11 is a perspective view from the underside of a first nut member forming part of the nut assembly;

FIG. 12 is a schematic cross-sectional view illustrating loading of the nut assembly (the nut assembly being illustrated as one-piece for the purposes of clarity);

FIG. 13 is a graph of load distribution along the engaging threads of the fastener assembly, with the nut construction illustrated in FIG. 12 as compared to a conventional nut construction;

FIG. 14 is a perspective view from the upperside of a second nut member (middle washer) forming part of the nut assembly;

FIG. 15 is a perspective view from the underside of the second nut member;

FIG. 16 is a cross-sectional view of the threaded fastener assembly fitted onto an externally threaded fastener such as a bolt;

FIG. 17 is an underside view of the elastic joint element, showing the contacting face thereof for engagement with a work-piece;

FIG. 18A is a cross-sectional view of a threaded fastener assembly formed into a joint according to a second embodiment;

FIG. 18B is a cross-sectional view of a prior art threaded fastener assembly formed into a joint for comparison with the joint in FIG. 18A;

FIG. 19 illustrates an alternative arrangement where the first nut member of the nut assembly is replaced with an externally threaded fastener assembly;

FIG. 20 is a partly exploded perspective view of a threaded fastener assembly according to a further embodiment, the threaded fastener assembly comprising a nut assembly;

FIG. 21 is a cross-sectional view of the threaded fastener assembly of FIG. 20;

FIG. 22 is a perspective view of the underside of a first member forming part of the nut assembly;

FIG. 23 is a perspective view from the upperside of a second member forming part of the nut assembly;

FIG. 24 is a cross-sectional view of a threaded fastener assembly according to a still further embodiment, incorporating a plurality of elastic elements arranged in series;

FIG. 25 is a perspective view of a threaded fastener assembly according to a still further embodiment;

FIG. 26 is a perspective view of an elastic washer forming part of the threaded fastener assembly of FIG. 25;

FIG. 27 is a perspective view of a first member of a nut assembly, with the first member being internally threaded using a multiple-start thread;

FIG. 28 is a schematic side elevational view (partly in section) of a threaded fastener assembly according to a still further embodiment;

FIG. 29 is a schematic perspective view of an elastic joint element incorporating a modified construction of the ratchet arrangement;

FIG. 30 is a cross-sectional side elevation of a schematic representation of a fastener assembly forming a joint according to the present invention;

FIG. 31 is an exploded perspective view of a portion of the fastener assembly of FIG. 30, the portion of the fastener assembly comprising a treaded fastener assembly and an elastic joint element;

FIG. 32 is a rendered upper perspective view of a further fastener assembly of another embodiment of the present invention;

FIG. 33 is a rendered lower perspective view of the fastener assembly of FIG. 32;

FIG. 34 is a cross-sectional side elevation the fastener assembly of FIG. 32;

FIG. 35 is a side elevation the fastener assembly of FIG. 32;

FIG. 36 is a bottom view of the fastener assembly of FIG. 32;

FIG. 37 is a side elevation of an elastic element of the fastener assembly of FIG. 32;

FIG. 38 is a cross-sectional side elevation of an elastic element of the fastener assembly of FIG. 32;

FIG. 39 is a close up of a portion of the cross-sectional side elevation of the elastic element of FIG. 38;

FIG. 40 is a bottom view of the elastic element of FIG. 38;

FIG. 41 is a partial cross-section of a side elevation of another embodiment of a fastener assembly of the present invention;

FIG. 42 is a plan view of the fastener assembly of FIG. 41;

FIG. 43 is a plan view of an elastic element of the fastener assembly of FIG. 41;

FIG. 44 is a side elevation of the elastic element of FIG. 43;

FIG. 45 is a cross-sectional side elevation of the elastic element of FIG. 43;

FIG. 46 is a partial cross-section of a side elevation of a further embodiment of a fastener assembly of the present invention;

FIG. 47 is a side elevation of the fastener assembly of FIG. 46;

FIG. 48 is a plan view of the fastener assembly of FIG. 46;

FIG. 49 is a side elevation of an elastic element of the fastener assembly of FIG. 46;

FIG. 50 is a cross-sectional side elevation of the elastic element of FIG. 48;

FIG. 51 is a plan view of the elastic element of FIG. 49;

FIG. 52 is a side elevation of a further elastic element of the present invention;

FIG. 53 is a cross-sectional side elevation of the elastic element of FIG. 52;

FIG. 54 is a plan view of the elastic element of FIG. 52;

FIG. 55 is a cross-sectional side elevation showing construction of the elastic element of FIG. 49;

FIG. 56A is a partial cross-sectional view of the elastic element of FIG. 49 before any loading is applied;

FIG. 56B is a partial cross-sectional view of the elastic element of FIG. 49 after a first load amount is applied;

FIG. 56C is a partial cross-sectional view of the elastic element of FIG. 49 after a second load amount is applied;

FIG. 57 is a enlarge cross-sectional side view of a portion of another elastic element of the present invention;

FIG. 58 is a rendered upper perspective view of a threaded fastener of the present invention;

FIG. 59 is a rendered lower perspective view of a threaded fastener of FIG. 58;

FIG. 60 is a side elevation of a threaded fastener of FIG. 58;

FIG. 61 is an enlarged side elevation of a portion of the threaded fastener of FIG. 58;

FIG. 62 is a cross-sectional side elevation of the threaded fastener of FIG. 58;

FIG. 63 is an enlarged cross-sectional side elevation of a portion of the threaded fastener of FIG. 58;

FIG. 64 is a bottom view of the threaded fastener of FIG. 58;

FIG. 65 is a side elevation of a threaded fastener of FIGS. 58 to 64 with an embedding protrusion;

FIG. 65A is a side elevation of an elastic element in the form of a nut;

FIG. 66 is a cross-sectional side elevation of the threaded fastener of FIG. 65;

FIG. 67 is a bottom view of the threaded fastener of FIG. 65;

FIG. 68 is an enlarged bottom view of a portion the threaded fastener of FIG. 65;

FIG. 69 is a side elevation of a threaded fastener of yet another embodiment of the present invention;

FIG. 70 is an enlarged side view of a portion of the threaded fastener of FIG. 69;

FIG. 71 is a cross-sectional side view of the threaded fastener rotated by 30 degrees from the view of FIG. 69;

FIG. 72 is a bottom view of the threaded fastener of FIG. 69;

FIG. 73 is a side elevation of the threaded fastener assembly including the threaded fastener of FIG. 69 coupled to the elastic element of FIG. 37;

FIG. 74 is an enlarged cross-sectional side elevation of a portion of the threaded assembly of FIG. 73;

FIG. 75 is a bottom view of the threaded fastener assembly of FIG. 73;

FIG. 76 is a side elevation of another embodiment of an elastic element according to the present invention;

FIG. 77 is a cross-sectional side view of the elastic element of FIG. 76;

FIG. 78 is a bottom view of the elastic element of FIG. 76;

FIG. 79 is a side elevation of a joint formed of a fastener assembly including a stack of elastic elements of FIGS. 76 to 78 in series;

FIG. 80 is a cross-sectional side elevation of the joint of FIG. 79;

FIG. 81 is a side elevation of a fastener in the form of a rivet of another embodiment of the present invention;

FIG. 82 is a partial cross-sectional side elevation of the rivet of FIG. 81;

FIG. 83 is a bottom view of the rivet of FIG. 81;

FIG. 84 is a cross-sectional side view of two joints formed using rivets of FIG. 81;

FIG. 85 is an enlarged cross-sectional side view of a portion of one of the joints of FIG. 84;

FIG. 86 is a cross-sectional side elevation of a fastener in the form of a pop rivet of a further embodiment of the present invention;

FIG. 87 is a bottom view of the pop rivet of FIG. 86;

FIG. 88 is a cross-sectional side view of two joints formed using pop rivets of FIG. 86;

FIG. 89 is an enlarged cross-sectional side view of a portion of one of the joints of FIG. 88;

FIG. 90 is a rendered lower perspective view of a fastener referred to as a huck bolt of yet another preferred embodiment of the present invention;

FIG. 91 is a partial cross-sectional side elevation of a joint formed of a fastener assembly in the form of an expanding sleeve bolt of an embodiment of the present invention; and

FIG. 92 is a partial cross-sectional side elevation of a joint formed of another fastener assembly in the form of an expanding sleeve bolt of an alternative embodiment of the present invention.

### DETAILED DESCRIPTION OF PREFERRED EMBODIMENTS

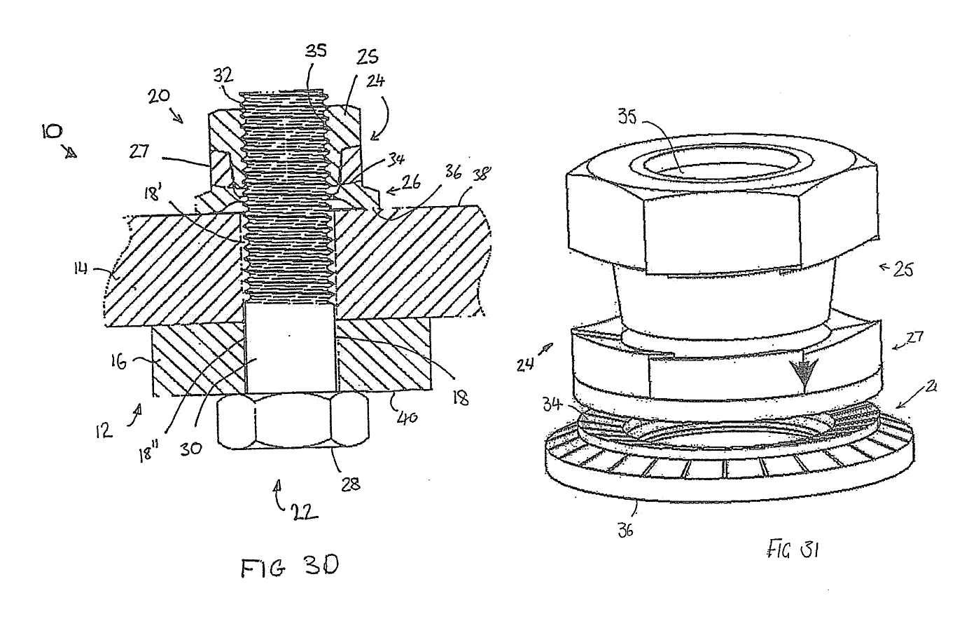

Referring to FIG. 30 there is shown a first embodiment of a joint 10 in accordance with the present invention. The joint 10 includes a work-piece 12 formed of a first work-piece component 14 and a second work-piece component 16. The work-piece 12 includes a hole 18 therethrough. The hole 18 is formed of hole section 18′ within work-piece component 14 and hole part 18″ within work-piece component 16. Hole sections 18′ and 18″ are coaxial and preferably of the same diameter.

The joint 10 is formed to couple work-piece component 14 to work-piece component 16. The joint 10 also includes a fastener assembly 20. In this embodiment the fastener assembly 20 is a threaded fastener assembly which includes an externally threaded fastener part 22, an internally threaded fastener assembly 24 and a resilient element 26. Externally threaded fastener part 22 is typically a bolt having a head 28 and a shank 30 extending from the head 28. An end part 32 of the shank 30 has an external thread thereon.

The internally threaded fastener assembly 24 includes an internally threaded fastener part 25 and a middle washer 27. The part 25 has an internal thread 35 lining a hole therethrough for threadingly engaging the external thread 32 of the externally threaded fastener part 22. The internally threaded fastener part 25 is typically a nut.

The resilient element 26 is a retaining washer in this embodiment for location between the nut 25 and the work-piece 12. More specifically in this embodiment the resilient element 26 is between the middle washer 27 and the work-piece 12. The resilient element 26 includes a load bearing surface 34 designed for the internally threaded fastener assembly 24 to apply a tightening load thereto. The resilient element 26 also has a work-piece engaging surface 36 for engaging a surface 38 of the work-piece component 14. The head 28 of the bolt 22 engages surface 40 of the work-piece component 16.

The joint 10 is constructed by threading the shank 30 of the bolt 22 through the hole 18 and placing the resilient element 26 so that its work-piece engaging surface 36 engages surface 38. The internally threaded fastener assembly 24 is then threadingly engaged into the threaded position 32 of the shank 30. Now that the joint 10 is formed it may be tightened to a pre-load point by rotating the internally threaded fastener assembly 24 in a direction so as to move it along the shank 30 in a direction towards the head 28, thereby applying a compressive force to the load bearing surface 34, which in turn transfers a compressive force to the surface 38 of the work-piece 12. Likewise the head 28 applies a compressive force to the surface 40 thereby compressively loading the work-piece 12.

The resilient element 26 is also compressed by this process. It has an elastic characteristic whereby it has resilient resistance to compression (elasticity). The elasticity of the resilient element 26 is greater than the elasticity of the other individual parts of the assembly 20. In particular the resilient element 26 maintains its elastic nature past the proof load of the bolt 22 and the internally threaded fastener assembly 24. This allows for the pre-load to be up to the proof load of the bolt 22, while still providing elasticity in the joint 10. In a preferred form the elasticity is characterised in that the elasticity changes at a predetermined point as the compressive force increases. The change in the elasticity characteristic is designed to change at about the proof load of the bolt 22.

One of the difficulties in pre-loading the joint is usually determining when the desired pre-load is reached. The present invention includes a method of determining whether the desired load is achieved. Typically it is between 60%-90% of the proof load of the bolt, but may be between 90% and 100% of the proof load of the bolt. It is important to properly pre-load the joint to achieve the best results from the joint.

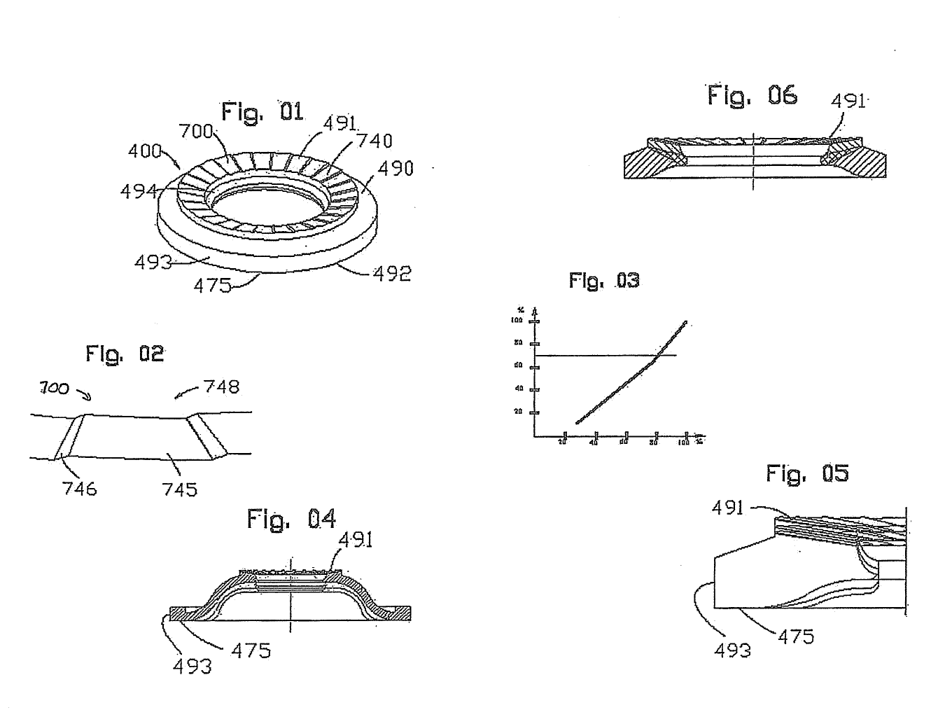

Referring now to FIGS. 1 to 7 of the accompanying drawings, there is shown a first embodiment 400 of an elastic joint element 28 for use in a threaded fastener assembly 22 which provides a joint 10.

The elastic joint element 400 of this embodiment comprises a washer having a generally annular body 490 with a first engaging face 491 for engagement with a component of a threaded fastener assembly (such as the internally threaded fastener assembly 20, which in a simple form may be a nut), and a second engaging face 492 for engagement with a flat assembly component, such as a flat washer or more usually the work-piece 12. The annular body 490 has a central axis, with the engaging faces 491, 492 each being of an annular configuration centered on the axis face 491 is equivalent to surface 34 and face 492 is equivalent to surface 36 of FIG. 30. The body 490 has a radial outer periphery 493 and a radial inner periphery 494 defining an aperture, which is centrally disposed with respect to the axis and which extends between the two engaging faces 491, 492.

The first engaging face 491 is of frusto-conical configuration, being disposed at an angle to a plane normal to the central axis of the elastic element. This provides the elastic element 400, and a complementarily-shaped component in engagement therewith, with a “self-centering” function. Other arrangements are, of course, possible some of which will be described further below. One such other arrangement is illustrated in FIG. 8 of the drawings where the face 491 is substantially flat and normal to the central axis of the elastic element 400. Another arrangement is illustrated in FIG. 9 where the face 491 is arcuate in cross section.

The face 491 is adapted for engagement with the component of the threaded fastener assembly in a manner allowing rotation of the fastener component in a tightening direction while inhibiting rotation in the unscrewing direction. For this purpose, the engaging face 491 is equipped with a structure 700 for mating engagement with a complimentary ramp structure on the fastener component. The engaging structures cooperate to provide a ratchet mechanism allowing rotation of the fastener component in the tightening direction while providing controlled rotation in the unscrewing direction. Controlled rotation in the unscrewing direction prevents unintentional unscrewing of the threaded fastener assembly in service while allowing the assembled fastener to be intentionally unthreaded in a convenient manner.

As shown in more detail in FIG. 2, the structure 700 has interposed ratchet ramps 748, each having a ramp face 745 and ramp shoulder 746 defining a ramp structure 740.

To allow ratchet clutch action (as will be explained in more detail later), the shoulder 746 of the ratchet ramp is inclined in the threading direction, sloping with a pitch higher than thread's pitch not exceeding 20 times value of thread pitch. (why 20 times?)

The elastic joint element 400 undergoes compression between the first and second engaging faces 491, 492 upon tightening of the threaded fastener assembly 20 in which the elastic element 400 is incorporated. The body 490 is constructed to be elastically deformable when subjected to such compression, with the compression having the characteristic that the elastic stiffness of the body increases in a single step during loading under compression.

The behaviour of the elastic joint element 400 during loading is depicted FIG. 3, where deflection (as a percentage of the maximum deflection of the joint element 400) on horizontal axis is plotted against force on vertical axis. The point of directional change in the plotted line represents the single step increase in elastic stiffness of the body. Force of 100% represents proof load of an internally threaded part of the joint, which causes 100% deflection on the graph. However this deflection does not need to completely flatten the elastic element. The horizontal line that crosses the graph represents force equivalent to proof load of externally threaded part. It can be seen that characteristic conveniently stiffens in that area allowing the element to withstand huge forces going far beyond these depicted on the graph without plastic deformations within the element.

The change in stiffness could be selected by design to take place at a clamping force lower than the proof load of bolt so that such change in stiffness is detected by the electronic control of assembly power tools. Thus, tightening could be stopped at a predetermined clamping force.

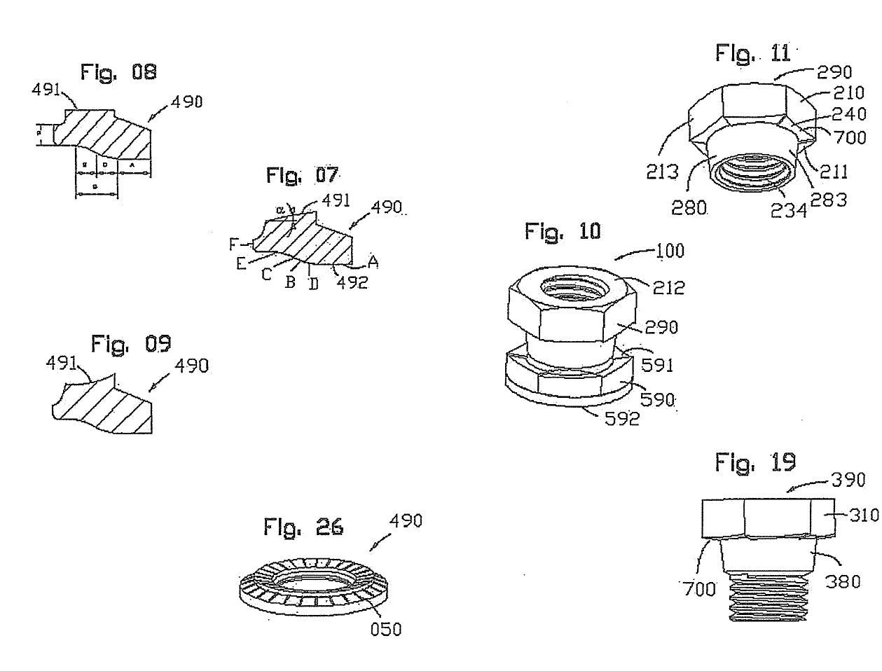

The variation in stiffness exhibited by the elastic joint element 400 is attained by virtue of the construction of the body 490. Specifically, the second engaging face 492 is of a construction involving a flat section A and a curved section B, as indicated in FIGS. 7 and 8. The curved section B has concavity and a point inflection C at which the concavity reverses. With this arrangement, the curved section B is generally of a “sloping S” configuration in cross-section, as best seen in the drawings. The concavity is inwardly facing with respect to the body 490 on the radially outer side of the point of inflection, and outwardly-facing on the radially inward side of the point of inflection. With this arrangement, the second engaging face 492 presents a convex portion D facing the work-piece and a concave portion E, also facing the work-piece, with the convex portion D being closer to the work-piece. During compression convex portion D will progressively move into contact with the work-piece, as shown in FIGS. 4 and 5 where various positions of the second engaging face are illustrated. From the drawings, it can be seen that the area of the convex portion D in engagement with the work-piece, progressively increases with increasing deflection of the elastic joint element.

The body 490 further includes a flange portion F extending inwardly at the inner periphery of the body to extend around the central aperture. The radial inner periphery 494 of the body defined by the flange portion Z is at a diameter smaller than the inner diameter of each of the first and second engaging faces 491, 492.

The curved configuration of the second engaging face 491 merges with the flange portion F.

The behaviour of the elastic element is explained with reference to FIGS. 4 to 6. FIG. 4 represents a theoretical, exaggerated cross-sectional shape and FIG. 5 one of possible implementations. Such a shape delivers superior elastic properties, contributing generally linear behaviour. The flange portion F holds the radial inner face 494 in position, preventing its collapse during operation particularly in high temperature environment as is the case with present art conical springs. The upturned peripheral section resists hoop spreading in a radial direction. Both figures show changing shape of the element during loading.

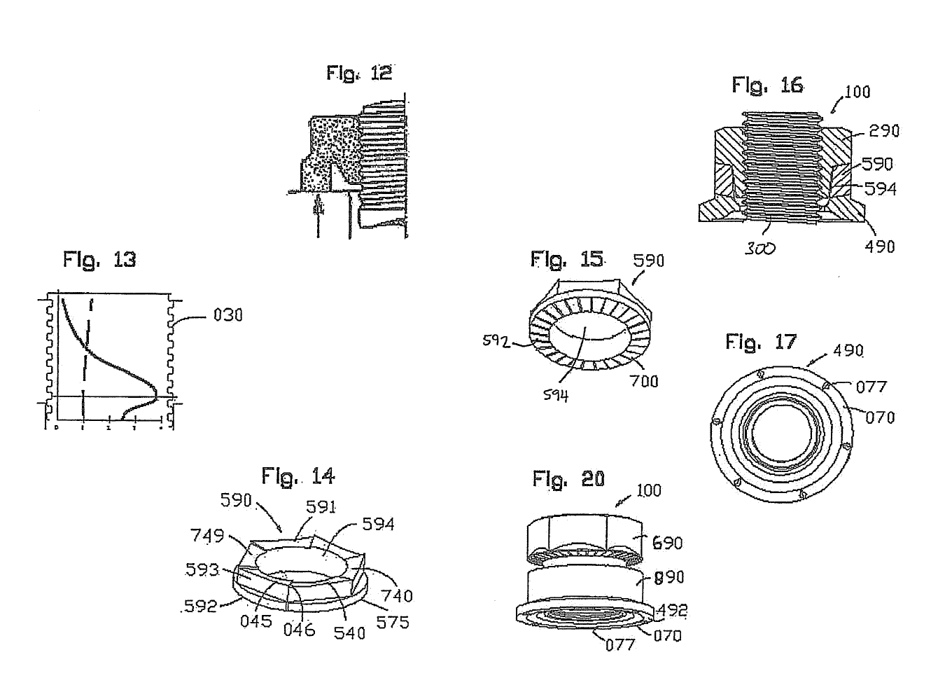

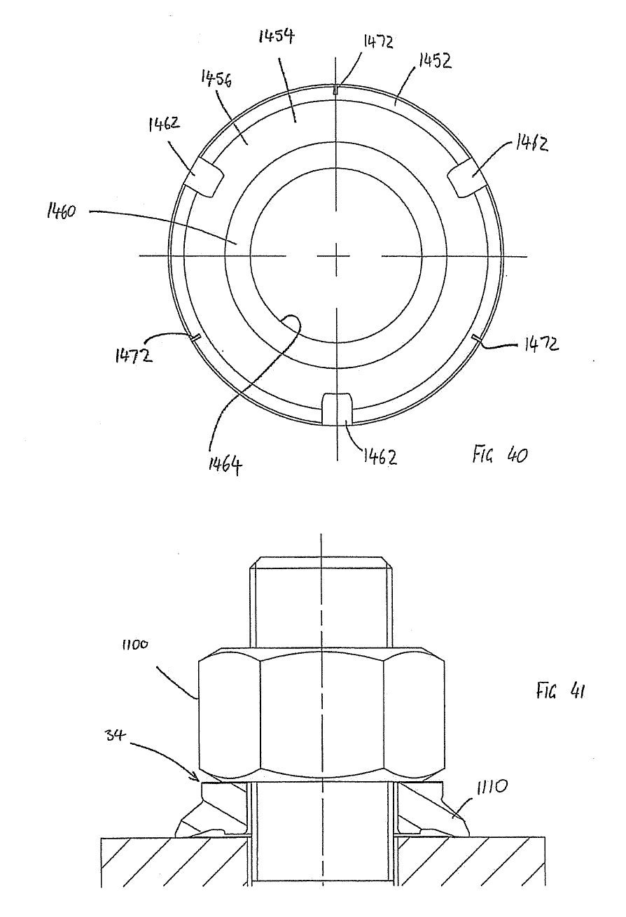

Referring now to FIGS. 10 to 19 of the accompanying drawings, there is shown a threaded fastener assembly according to a second embodiment. The threaded fastener assembly comprises a nut assembly 100 for threadingly engaging a bolt 300, and also an elastic element 26 of the type according to the first embodiment 400, the threaded fastener assembly being best seen in FIG. 31 of the drawings. It is relevant to note at this point that the relative size of the nut assembly 100 forming a joint in FIG. 18A is only marginally bigger than a standard threaded fastener joint shown in FIG. 18B. It is also noted that the elastic element may be of the type shown in FIGS. 37 to 40 described further below.

The nut assembly 100 is equivalent to the internally threaded fastener assembly 24 in FIG. 30 and comprises two parts, being a first nut member 290 and a second nut member 590.

The first nut member 290 comprises a head portion 210 and a projection portion 280 extending axially from the head portion, with an engaging face 211 on the head portion surrounding the projection portion 280. The outer periphery of the head portion 290 is provided with means to facilitate turning thereof, such as wrenching flats in the manner of a conventional nut for the purposes of engagement by way of a spanner or wrench.

The projection portion 280 has an outer radial periphery surface 283 tapering inwardly towards the free end of the projection portion so as to be generally frusto-conical in shape.

The first nut member 290 has a threaded hole 234 therein for threadingly engaging an externally threaded fastener such as a bolt 22. The thread extends through both the head portion 210 and the projection portion 280. This arrangement provides for a nearly even load distribution at the threaded engagement between the nut 290 and the bolt, in contrast to conventional nuts where the majority of the load is taken by the first few threads. The manner of threaded engagement between the nut 290 and the bolt 300 is illustrated schematically in FIG. 16 of the drawings. FIG. 13 is a graph of load distribution along the engaging threads between the nut 290 and the bolt, with the relationship being depicted by the broken line. The graph also includes, for the purposes of comparison, a representation of the load distribution in a conventional nut and bolt, such representation being by way of the solid line in the graph.

The second nut member 590 operates as a middle washer 27 between the first nut member 290 and the elastic element 400. The second nut member 590 comprises a body having a first engaging face 591 for facing engagement with the engaging face 211 of the first nut member 290, and a second engaging face 592 for facing engagement with the first engaging face 491 of the elastic washer 490. The body further includes a central hole 594 for receiving the projection portion 280 of the first nut member 290 with a clearance fit therebetween, as best seen in FIG. 16 of the drawings.

The engaging faces 211 and 591 on the first nut member 290 and the middle washer 27 are preferably angled so as to provide a self centering feature. In addition the middle washer may be harder than the nut member. Furthermore the angles of the faces 211 and 591 may differ slightly so that the contact therebetween can be made to increase as loading increases and the nut (if the middle washer is more rigid) distorts. This can achieve an elastic effect between these components.

The second engaging face 592 is larger than the first engaging face 591 in order to provide a larger area at the interface between the second nut member 590 and the elastic element 490 to accommodate the ratchet mechanism operating therebetween.

Similarly to the faces 211 and 591 faces 592 and 490 may be provided with slopes so as to be self centering. An angle of between 10 and 15 degrees is most suitable. In addition the angles of the faces may again slightly differ by amount 1-3 degrees to provide similar progressively increasing contact surface and correspondingly elasticity between these components.

The first nut member 290 and the second nut member 590 are in facing engagement through their respective faces 211, 591. A mechanical connection is provided between the first nut member 290 and the second nut member 590 for coupling them together for rotation in unison when the first nut member is rotation in the tightening direction, and for urging the first and second nut members axially apart in response to rotation of the first nut member relative to the second nut member in the unscrewing direction. The mechanical connection in this embodiment is provided by a ramp structure 240 on the engaging face 211 of the first nut member 290 and a complimentary ramp structure 540 on the engaging face 591 of the second nut member 590. The ramp structures 240 and 540 cooperate so that shoulders of the wedges engage when the first nut member 290 is rotated in the tightening direction, thereby driving the second nut member in the same direction. The ramp structures 240, 540 also cooperate to provide a wedging action for wedging the two nut members 290, 590 axially apart in response to rotation of the first nut member 290 in the unscrewing direction. For this purpose, each ramp structure 240, 540 comprises a series of wedge sections 749 having a wedge pitch greater than the pitch of threads, whereby rotation of the first nut member 290 in the unscrewing direction causes the threads to jam and consequently inhibits further rotation in the unscrewing direction.

The second engaging face 592 of the second nut member 590 is provided with the ratchet structure (referred to earlier) for cooperative engagement with the ratchet structure on the elastic washer, as described previously.

The facing surfaces 591 and 211 at which there is engagement between the first and second nut members 290, 590 are configured for centering alignment therebetween. This is achieved by having the surfaces of frusto-conical or curved configuration such that the load bearing surface of the first nut is convex and the surface of the second nut is concave or first nut is concave and the second nut is convex.

Similarly; the facing surfaces between the elastic washer 400 and the second nut member 590 are also configured for centering therebetween. Again, this is achieved by having the facing surfaces of frusto-conical or curved configuration. Again by the face of the second nut being convex and the face of the elastic element being concave or the second nut being concave and the face of the elastic element being convex.

To keep the assembly reasonably compact, the retainer washer 400 might need to be equipped with embedding protrusions 077 on the face 070 thereof, as evident from FIG. 17.

In the embodiment previously described, the fastener element was in the form of a nut assembly 100. It should be understood that the fastener element can also be in the form of a bolt, with the head of the bolt being of one or two part construction along similar lines to the nut assembly 100. FIG. 19 of the drawings illustrates the first member 390 of a first embodiment of a bolt according to this aspect of the present invention. The first member 390 comprises a head portion 310′ and a projection portion 380 extending axially from the head portion, with an engaging face on the head portion surrounding the projection portion. The threaded shank of the bolt extends from the projection portion, as shown in the drawing.

In the embodiment described previously, the thread fastener assembly comprised the nut assembly 100 of two-part construction, as well as the elastic element 400.

The embodiment shown in FIGS. 20 to 23 uses some of the characteristics of the previous embodiment in that it incorporates an assembly 100 which provides a nut 690 and a retainer washer 890. In this embodiment, however, the nut 690 incorporates some of the features of the first nut member 290 of the earlier embodiment, and the retainer washer 890 is constructed so as to incorporate some of the features of the second nut member 590 of the earlier embodiment.

In this way, the nut assembly 100 is still of two-part construction, one part being the nut member 690 (or a bolt member) and the other part being the retainer washer 890.

The nut member 690 comprises a head portion 210 and a projection portion 280 extending axially from the head portion, with an engaging face 211 on the head portion surrounding the projection portion. The projection portion 280 has an outer surface tapering inwardly towards the free end of the projection portion.

The nut member has a threaded hole therein for threadingly engaging the bolt. The thread extends through both the head portion 210 and the projection portion 280. This arrangement provides for a nearly even load distribution at the threaded engagement between the nut member 290 and the bolt, as was the case with the earlier embodiment.

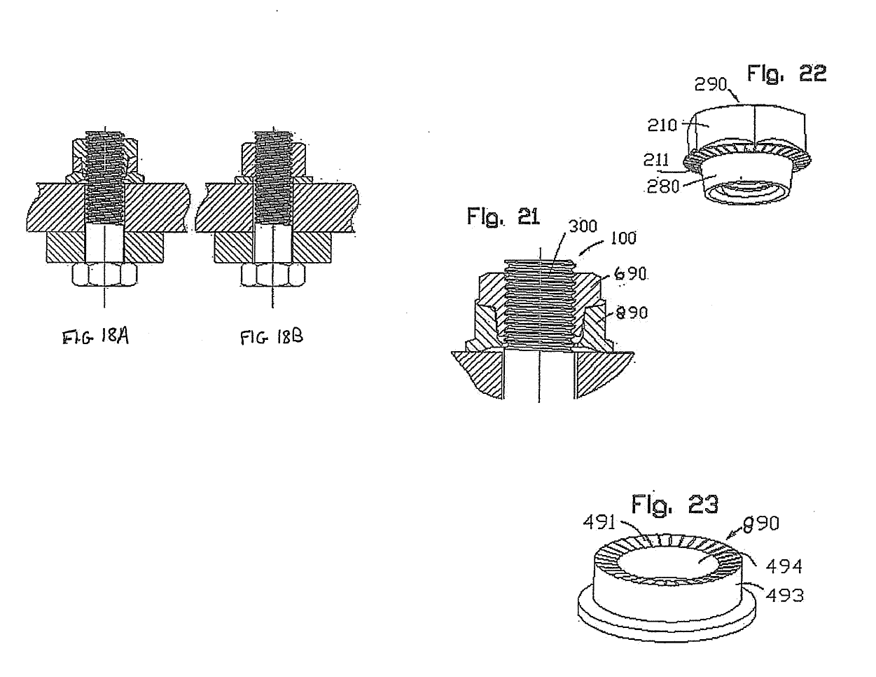

The retainer washer 890 comprises a body having a first engaging face 491 for engagement with the nut member 290 and a second engaging face 492 for engagement with a work-piece. The nut member 290 is internally threaded for threadingly engaging bolt 300. The body has a central axis, with the engaging faces 491, 492 each being of annular configuration centred on that axis. The body has a radial outer periphery 493 and a radial inner periphery 494 defining a central aperture for receiving the projection portion 280 of the nut member 690 with a clearance fit therebetween, as best seen in FIG. 21.

The nut member 690 and the retainer washer 890 are in facing engagement through their respective engaging faces which incorporate a ratchet mechanism allowing rotation of the nut member in the tightening direction while providing controlled rotation in the unscrewing direction. The ratchet mechanism is similar to that operating between the nut assembly 100 and retainer washer 490 of the earlier embodiment.

The retainer washer 890 of this embodiment is configured to exhibit the elastic behaviour of the elastic joint element 490 of earlier embodiments. In this regard, the annular, body of the retainer washer 890 incorporates the flange portion extending inwardly at the inner periphery of the body to extend around the central aperture, and the curved configuration of the face 492, as was the case with the earlier embodiment.

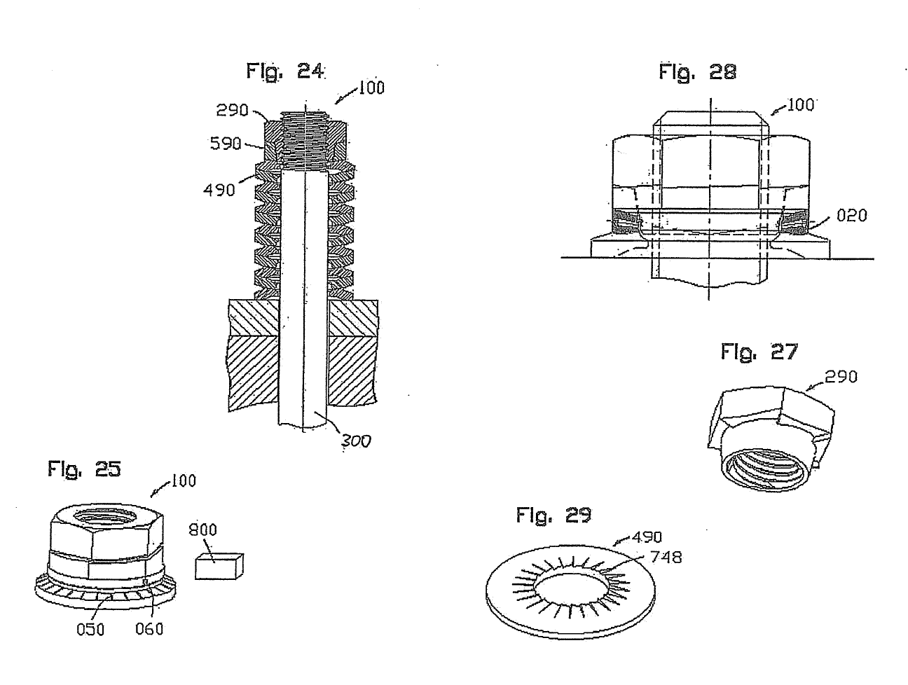

Referring now to FIG. 24, there is shown a threaded fastener assembly incorporating a plurality of elastic elements 490 arranged in series. In this embodiment the elements are of dished configuration, as shown in the drawing, to facilitate self-centering one with respect to another in the series. By placing the elastic elements in series the deflection achievable due to the elements elasticity is increased.

Referring now to FIGS. 25 and 26, there is shown a threaded fastener assembly according to a still further embodiment. The threaded fastener assembly is similar to that of the second embodiment, with the exception that it incorporates an arrangement for providing an indication of the extent to which the threaded fastener assembly is loaded. For this purpose, the nut 100 incorporates a pointer 060 on the second member 590 thereof. The pointer 060 operates in association with a scale 050 marked on an exposed portion of the elastic element 490. The pointer 060 and the scale 050 can be used to determine the extent to which the nut assembly 100 is tightened after coming into frictional engagement with the elastic washer 490. This can be useful to establish a prescribed preload, with the preload being accurately determined by the extent to which the nut is rotated after initial frictional contact with the elastic washer.

Because of the ratchet mechanism operating between the second nut member 590 and the washer 490, there is an audible “clicking” noise generated upon rotation of the nut relative to the washer in the tightening direction after initial engagement therebetween. The “clicking” noise is, generated as the ramp structures ride up the long ramp face of the elastic element causing separation between the body of the elastic element and the adjacent fastener component (middle washer 590 or nut 690). During this movement apart the displacement is absorbed by the resilience of the elastic element. As the ramp structures pass the peak they, will rapidly descend the shoulder portion of the ramp structure due to a combination of the tightening force as well as the slight relaxation of the absorbed displacement in the elastic element. The ramp faces will then impact on one another. The impact causes the “clicking sound”.

Such a “clicking” noise can be utilised to regulate the extent of preloading of the fastener, assembly. This can be done, for example, by specifying that the tightening procedure should be to a prescribed number of “clicks” in the assembly. For this purpose, there can be used an acoustic pick-up or detector 800 which, in combination with an amplifier and a speaker, or a counter with a display, or any other appropriate device, can aid precision loading of the assembly by counting the number of “clicks”.

As an alternative to the detector 800 an electronic counter may be employed to counts a predetermined number of clicks and then disconnect power to a power tool for tightening the nut assembly. In this way a number of clicks can be set and the power tool used to tighten the nut assembly thereby tightening the joint to the desired level, whereupon power will be cut when the desired clamping force is achieved as indicated by the preset number of clicks.

In the embodiments previously described, the threaded fastener assemblies utilised single-start threads. Other arrangements are, of course, possible. By way of example, FIG. 27 illustrates the first member of a nut of two-part construction, with the first member being internally threaded using a multiple-start thread. Such a multistart thread could equally be applied to the embodiment of the nut 690.

To improve performance of the assemblies, friction-reducing measures can be implemented. They might include a variety of lubricants on some or all internal assembly surfaces and also on the thread. For bigger fasteners, it may be advantageous to introduce roller bearings 020 with two-part cages as shown in the embodiment of FIG. 28. The lower part of the cage centres on the retainer washer but is allowed to rotate relative to the retainer washer. The cage components can be spot welded or assembled using fasteners such as rivets.

An elastomer seal may be fixed to the middle washer. It rotates relative to the lower washer and moves up and down as rollers move on ratchets.

Roller bearings can also be placed in grooves on one of the interacting structures and allowed to rotate on the opposite structure's ratchets.

The embodiments have been described with ratchet ramps of one type of construction. It should be appreciated that the ratchet ramps can be constructed in any appropriate way. An alternative form of construction of ratchet ramps is illustrated in FIG. 29 of the drawings.

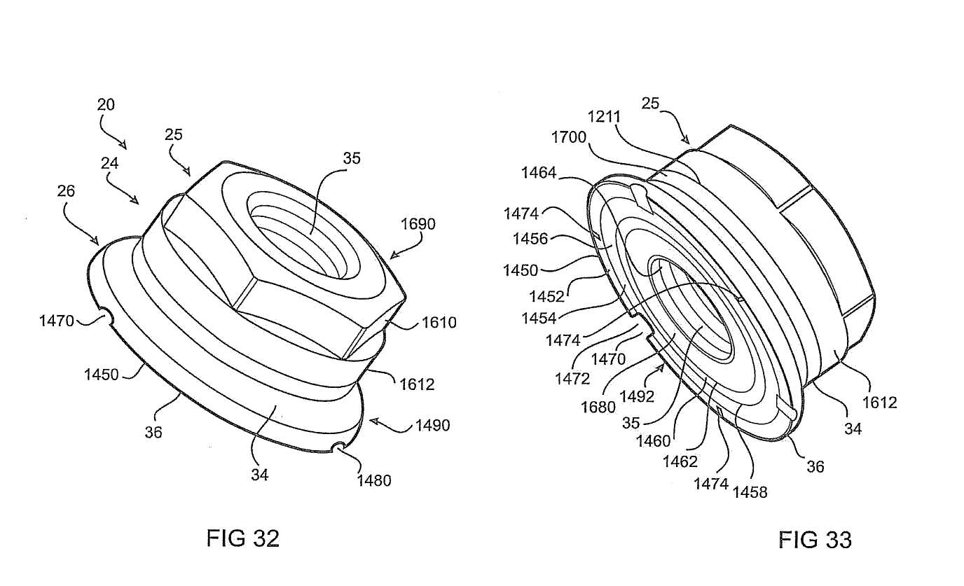

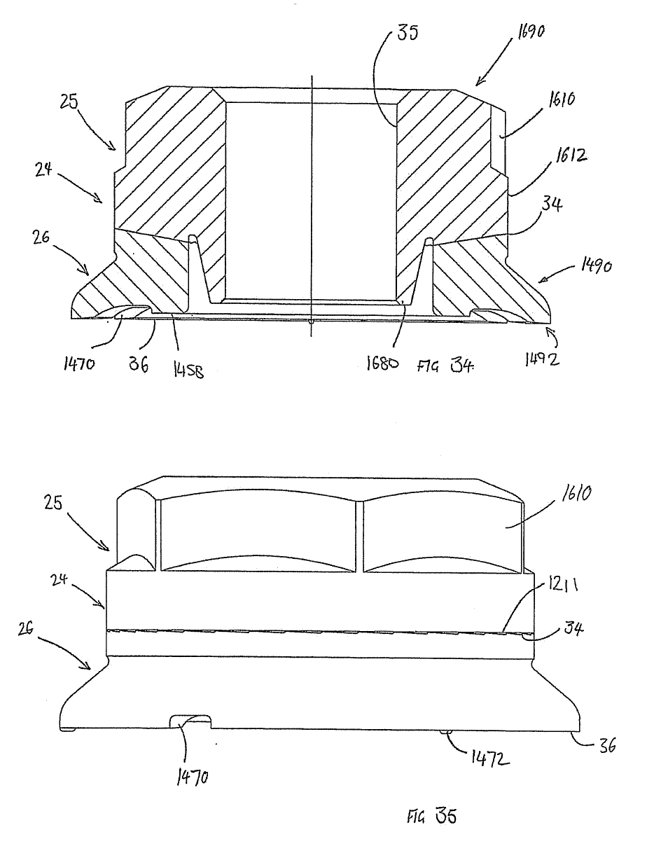

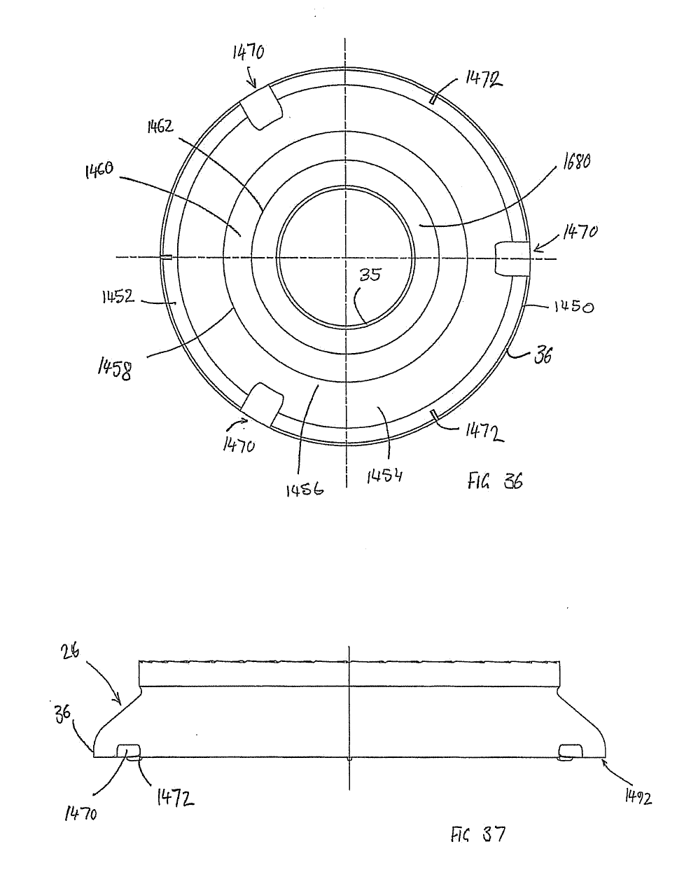

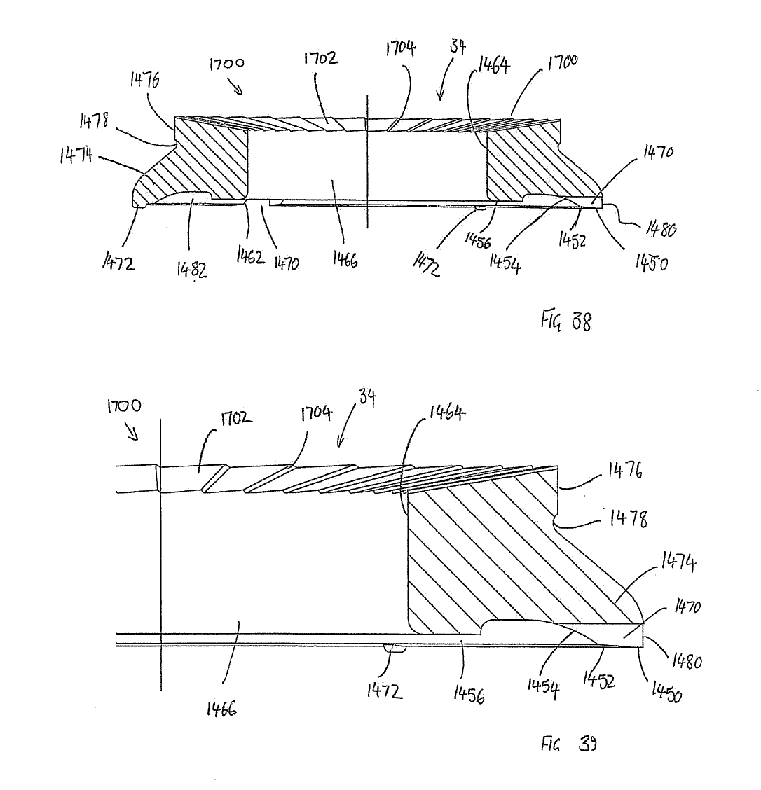

Referring to FIGS. 32 to 35 there is shown a particular preferred embodiment 1690 of the threaded fastener assembly 24 and preferred embodiment 1490 of the elastic element 26. The threaded fastener assembly 1690 is a nut. The nut includes a head 1612 with spanner flats 1610 in a standard hexagonal arrangement and a frusto-conical projecting portion 1680. The nut is generally similar to that described in relation to FIG. 22. On the underside of the head is a load bearing surface 1211 on which is a circular arrangement of ramps similar to the ramps on face 211 previously described. The nut has a projecting portion 1680 similar to the projecting portion 280.

The elastic element 1490 is, similar to the embodiment shown in FIG. 23 although it is generally more bell shaped. Load bearing surface 34 is in the form of a circular set of ramps of complementary shape to the ramps on the surface 1211 of the nut.

In addition the surface 36 has a different profile to that shown in FIG. 17. The profile is curved and forms a circular cavity recessed from the rim. The work-piece engaging surface 36 profile is formed of a plurality of surface sections 1452, 1454, 1450, 1460 and 1456 that will contact the surface 38 of the work-piece 12 depending upon the compressive force applied to the elastic element 1490. In addition three notches 1470 are formed in the perimeter by forming a cut-away 1472 in the peripheral surface and within some of the surface sections 1450, 1452, 1454 so that access to the inside of the cavity within the elastic element 1490 can be gained. Furthermore embedding intrusions 1474 are functionally equivalent to 077 in FIG. 17.

The elastic element 26 is described in more detail in relation to FIGS. 37 to 40 and 55. As best seen in FIGS. 38 and 39 the engaging system 1700 is formed by a series of ramps, each ramp having a long ramp face 1702 and a shoulder 1704. The ramps are arranged in a direction such that upon rotation of the nut 1690 in a tightening direction, that is usually clockwise, the mating structure, (such as another set of ramps) ride up the long face 1702 and then fall down the shoulder 1704 on to the next ramp, and so on. In the untightening direction the shoulders must ride up one another and then descend the long face 1702 of the ramps. The displacement caused by movement in either direction up the ramps must be relatively small so as to not act as a wedge but rather as a resistance to rotation in the untightening direction. But such resistance may be overcome with the displacement being absorbed by the resilient element and/or slack in the thread of the fastener. As described earlier this rotation causes a “clicking sound”.

As shown in FIG. 55, the elastic element 26 is generally formed of a first load bearing section 1430, upon which the ratchet mechanism 1700 is located. The first section receives the loading force of the internally threaded element 20. The first section 1430 is generally annular in shape and in this embodiment the surface upon which the nut engages is generally concave so as to provide a self-centering feature. Extending downwardly from the first section 1430 is a generally cylindrical portion 1432 through which is an aperture 1466 for the bolt to pass through. The cylindrical portion 1432 resists inward curling as the load increases. Extending from the first section 1430 and the cylindrical section 1432 is a generally curved flange portion 1434 which forms an inverted dish shape, wherein there is a cavity 1436 formed within the dish. The cavity 1436 extends into the central aperture 1466. The surface 1438 defining the cavity is profiled with a varying shape so as to divide the adjacent component (work-piece) contacting surface 36 into a number of sections as described above.

When the surface 36 makes contact with the work-piece or other adjacent component the embedding projections 1472 will make contact. As the joint is tightened these will embed in the work-piece (or adjacent component). As they are relatively small, a large amount of force will be concentrated on the small area which will encourage them to quickly embed within the work-piece. There embedment provides a mechanical engagement so as to prevent the elastic element from rotating relative to the work-piece. Thereafter peripheral surface 1450 generally at the rim of the flange 1474 will make contact as shown in FIG. 56A. Surface 1450 is a relatively thin flat annulus or simply a circular rim. Inwardly adjacent to the surface 1450 is a slightly inclined (possibly curved) surface 1452 of generally frusto-conical shape. As compression increases flange 1474 will deflect allowing the surface section 1452 to increasingly make contact with the work-piece as shown in FIG. 56B.

The cavity 1436 inside the flange is mostly formed by a circular depression or recess 1482, the inside surface of which is divided into a curved portion 1454, a flat portion 1456 and a sharply curved portion 1458. Inwardly from the sharply curved portion 1458 is the flat surface 1456 of the cylinder portion which projects towards the work-piece from the relatively flat surface 1456. This surface 1456 is therefore level with a point part-way along the curved surface 1454, inwardly of conically shaped surface 1452 and annular surface 1450.

Thus as compression increases, deflection of the flange 1454 occurs. In turn, contact between the element 1490 and the work-piece increases adding section 1452 and then part of section 1454 until the section 1460 makes contact as shown in FIG. 56C. Further compression results in the remainder section 1454 making contact as well as sharply curved section 1458 possibly up until contact with the section 1456 is made. The transition between the different surface sections 1450, 1452, 1454, 1456, 1458 and 1460 allows for varying the characteristics of the stiffness of the element. (As will be explained in other embodiments further variations upon this may be made.)

It is noted that alternative profiles of surface 36 can be constructed using flat sections, slopes, curved concave/convex shapes and shapes to control the manner of contact and the change in stiffness characteristic as to amount of compression progressively increases with loading.

Notches 1462 allow access into the cavity 1482. Advantageously access to the cavity can be used to measure the extent of compressive force applied, by for example checking the gap between surface 1460 and the work-piece with a feeder gauge or with a light beam. The cavity also includes the clearance between section 1460 and the work-piece during assembly of the joint up until the point where the surface section 1460 makes contact with the work-piece. This point is preferably designed to be at pre-load amount of the joint, usually just before or even at about the proof load point of the bolt. Thus the elastic characteristic of the element will provide a sharp increase in stiffness when the desired pre-load amount of the bolt is reached but it will still retain elasticity past this point.

Such a sharp increase in the stiffness characteristic can be sensed by a current sensing device in power tool applying a tightening force to the nut. This in turn can be used to shut off power to the power tool, thereby tightening the nut to the desired extent, but no more.

The tightening force required to cause the surface section 1460 to contact the adjacent component (eg the work-piece) can be marked (such as by engraving, embossing or printing on the exterior surface of the flange 1454) so that the appropriate elastic element can be selected for inclusion in the joint to achieve the desired (pre-)loading. The selection of the elastic element will usually be made in combination with selection of the bolt appropriate to form the joint. The change is stiffness may be enough to be felt by a human.

FIGS. 3B and 3C depict typical behaviours of an elastic joint element 1490 under a compressive load. The axes of the graph are identical to that in FIG. 3. As shown on the graph in FIGS. 3B and 3C, there is a step change in the elastic stiffness of the body. This corresponds to the surface section 1460 of the work-piece engaging surface 36 contacting the work-piece or an adjacent component. Thus, for compressive forces larger than this point of step increase there is no further deflection of the elastic joint element 1490.

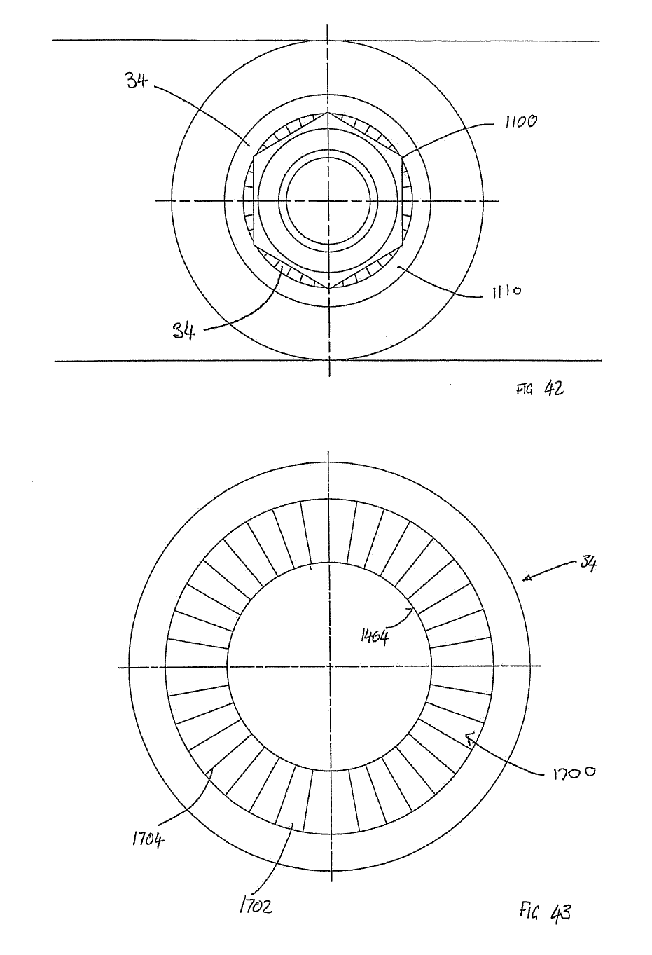

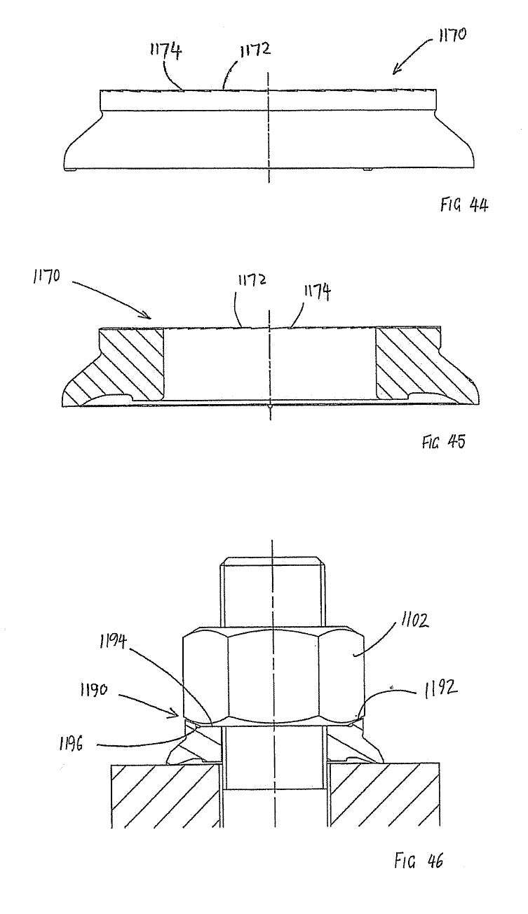

FIGS. 41 to 45 show a variation to the elastic element and nut whereby a standard nut 1100 is used with elastic element 1110. This element is similar to that described in relation to FIGS. 32 to 43. The main difference is the surface 34 which is generally of a flat annular configuration similar to that shown in FIG. 8. The ratchet mechanism 1700 is located on this surface. The ratchet mechanism 1700 may bite into, the load bearing surface of the standard nut 1100. It is worth noting here that the long faces 1702 and shoulders 1704 may be hardened by appropriate treatment so as to be of greater hardness than the load bearing surface 1100 of the nut.

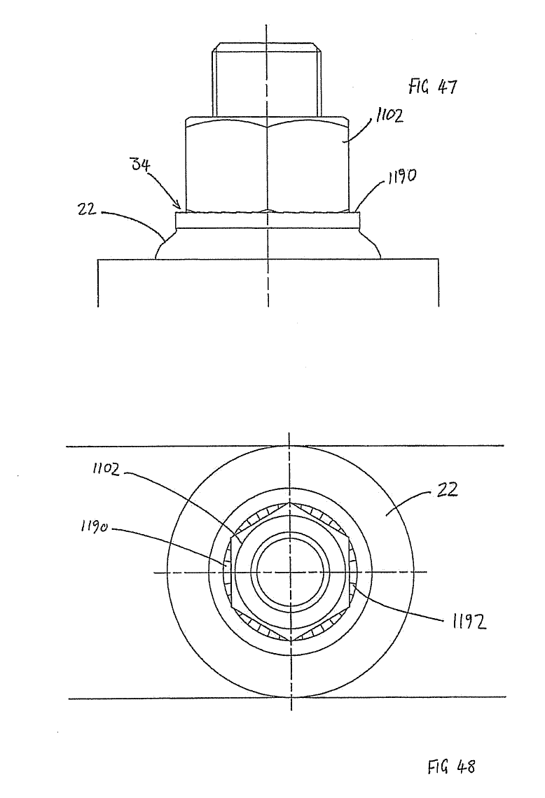

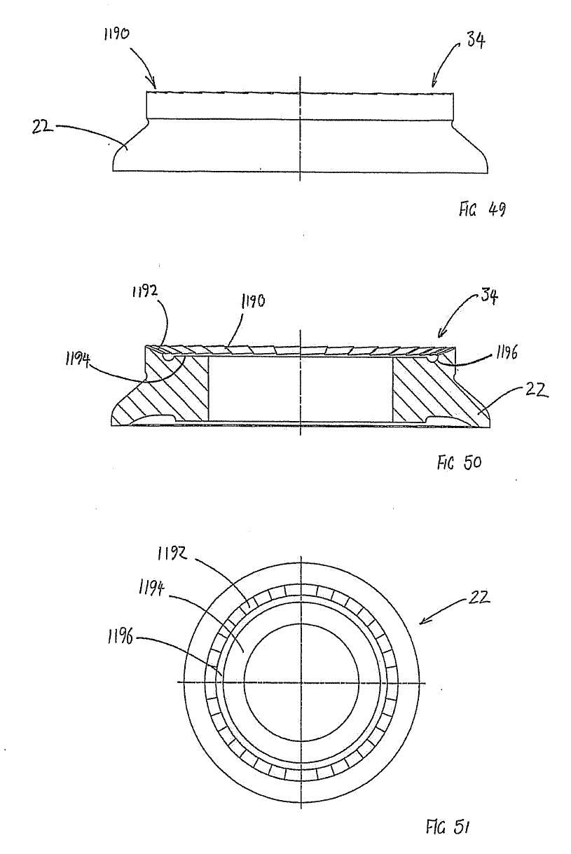

Referring to FIGS. 46 to 51, a further variation of the elastic retaining washer 22 is shown, where the difference is again in surface 34. In this embodiment the surface 34 is profiled in cross section so as to have a flat annular portion generally perpendicular to, the central axis and a sloped part 1192, frusto-conical in overall shape, designed to fit within a conical peripheral portion of a standard nut 1102. In this embodiment the engaging mechanism 1190 is again formed from a set of ramps forming a circular ratchet structure on the sloped part 1192. The sloped part 1192 is radially spaced from the annular surface 1194. Separating the sloped part 1192 from the annular portion 1194 is a curved groove 1196 which eliminates a sharp transition so as to evenly distribute stress.

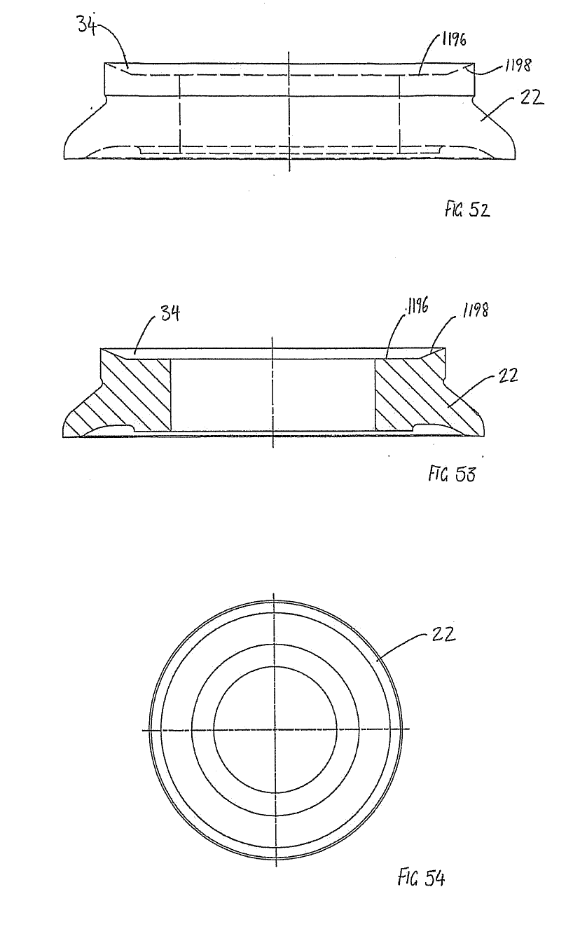

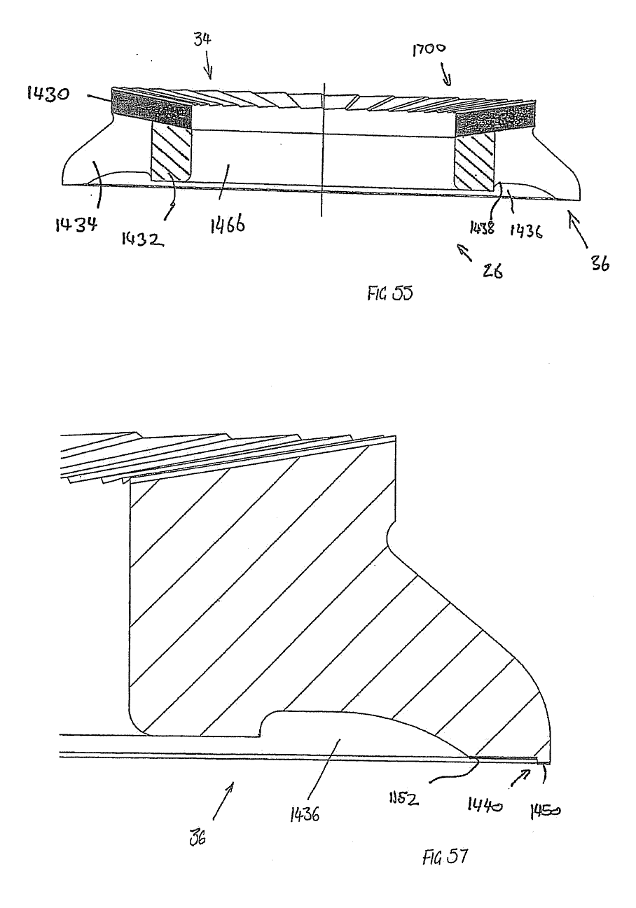

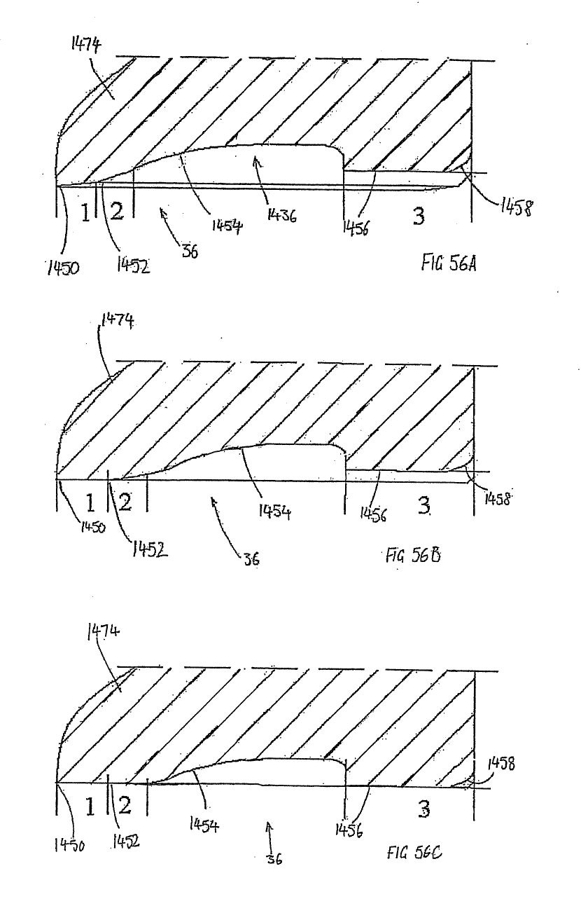

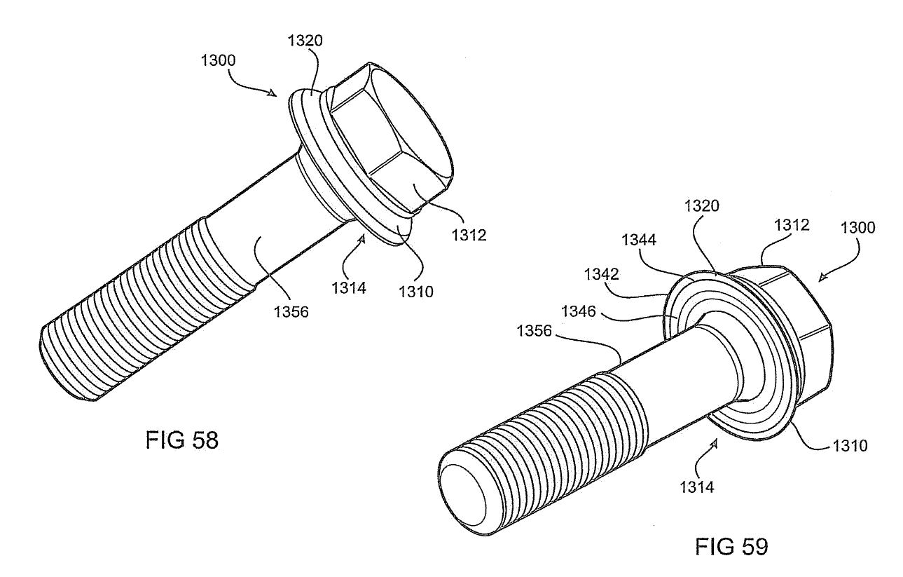

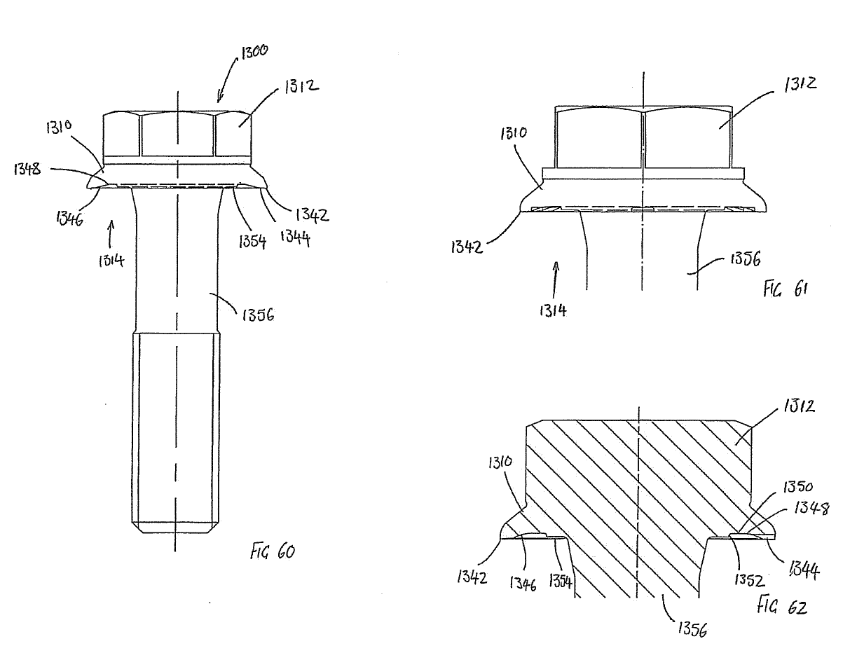

FIGS. 52 to 54 show a further variation in which surface 34 includes flat annular portion 1196 and a sloped portion 1198. The sloped portion 1198 is also designed to mate with the conical/chamfered edge of a standard nut. However in this embodiment no ratchet system is provided on the portions 1196 and 1198. In other words the surface of the nut that slides over surface 34 are both smooth surfaces.

A further variation of the surface 36 on the underside of the dished flange 1436 is shown in FIG. 57. In this figure the surface 1450 is thicker and a step 1440 is provided between surface 1450 and the surface 1152 which has a flat annular shape. This configuration is particularly useful when it is used to provide a seal between the outside of the flange and the inside as this will partially embed in the work piece thereby causing a seal.

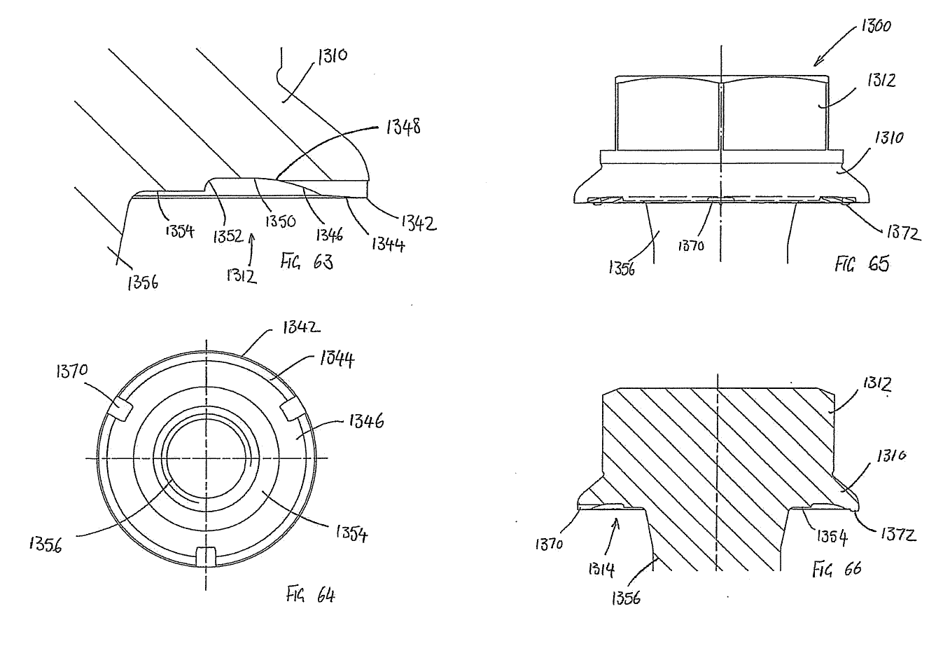

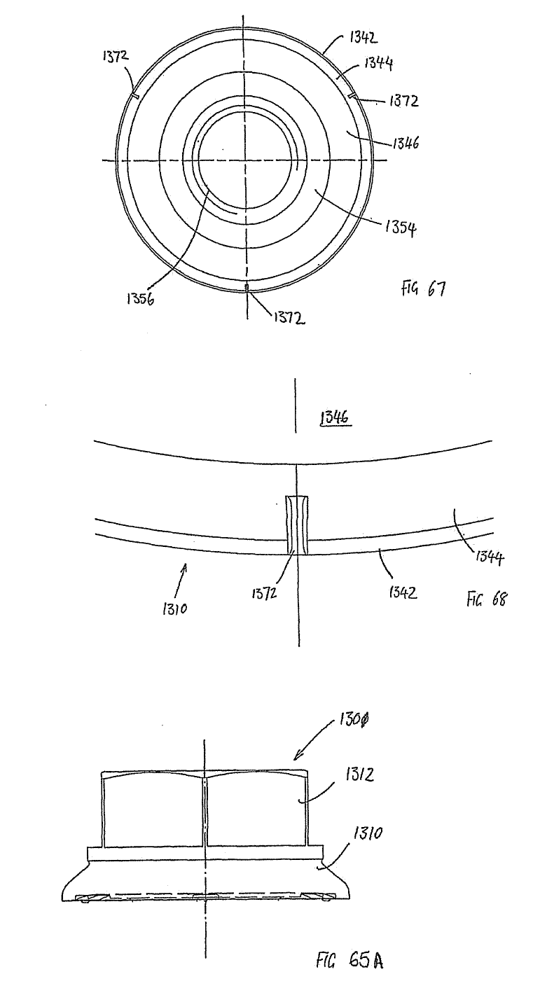

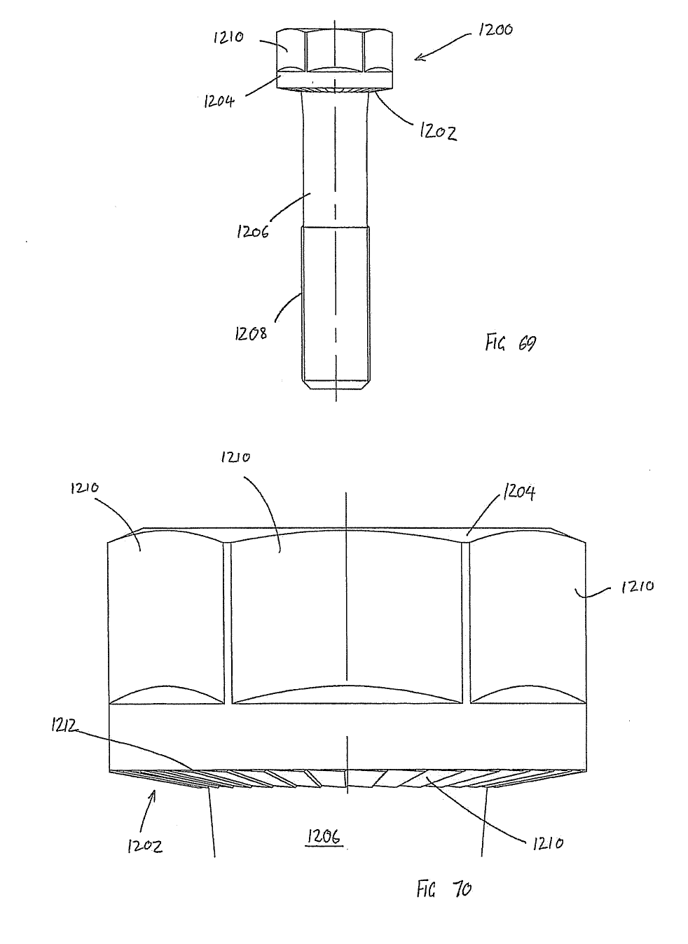

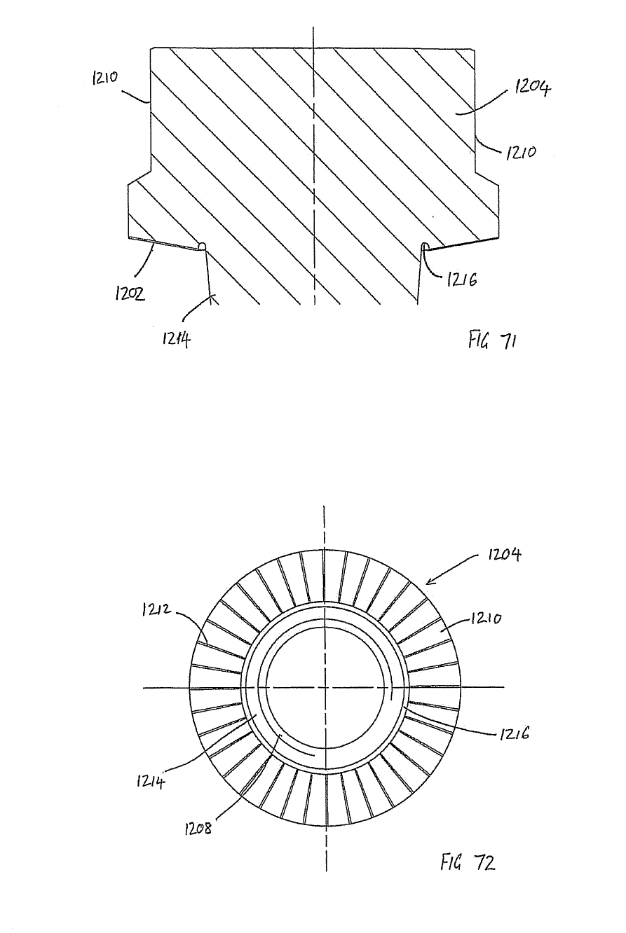

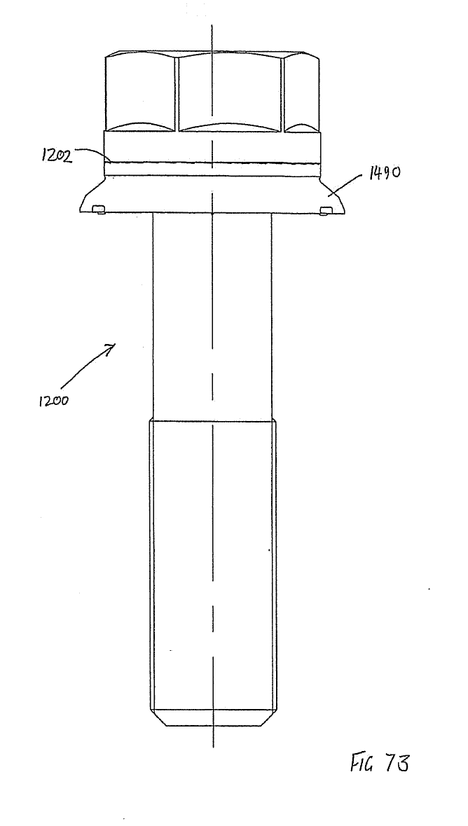

Referring to FIGS. 58 to 68, in this embodiment the bolt 1300 includes the elastic element in the form of a curved flange 1310 which radially extends from the head 1312 of the bolt 1300. The flange 1310 in this embodiment operates similarly to the curved flange of the embodiment of FIGS. 32 to 43. It has an undersurface 1314 which makes contact with the work-piece or an adjacent component such as a standard flat washer. The resilience of the bolt 1300 comes from deflection of the flange 1310, which is controlled by the shape of the contacting surface 1314. Surface 1314 is comprised of a peripheral contacting surface 1342 at a rim of the flange 1310 and then progressing inwardly, a frusto-conical shaped surface 1344, a further curved surface 1346, a point of inflection 1348, a flat section 1350, a sharply curved 1352, a flat section 1354 and then a tapered section forming part of the shank 1356 of the bolt 1300. The curved surfaces 1346, 1352 and flat surface 1350 define a recess section 1358 which forms part of the cavity inside the flange 1310. As with the embodiment in FIGS. 32 to 43 increased compression applied by loading the joint progressively increases the surface sections contacting the work-piece thereby providing a change in the elastic characteristic of the threaded fastener. FIGS. 65 to 68 show a variant of the threaded fastener of FIGS. 58 to 64. There are two variations included in this variant either of which or both may be incorporated. Both are shown in the drawings. The first point of difference is the notches 1370 which are similar to those 1470 described in FIG. 30. The other point of difference is the embedding protrusions 1372 which are similar to those 1474 described in relation to FIGS. 32 to 43.

FIG. 65A shows a nut 1301 with a flange 1310 and profiled surface 36 similar to that of the bolt in FIG. 65.

Referring to FIGS. 69 to 72 there is shown a externally threaded fastener 1200 having a head 1204 and a shank 1206 with thread 1208. The head 1204 had wrench flats 1210 and an engaging surface 1202 formed of a set of ramps having a long face 1210 and a shoulder 1212. The ramp structure form a set of ratchets that cooperate with a similar structure of the elastic element 1490 described in FIGS. 32 to 43. At the top part of the shank where it meets the head 1204 a frusto-conical portion 1214 is provided to better distribute loading in the head 1204. Curved interface 1216 reduces stress in the interface between the portion 1214 and the surface 1202.

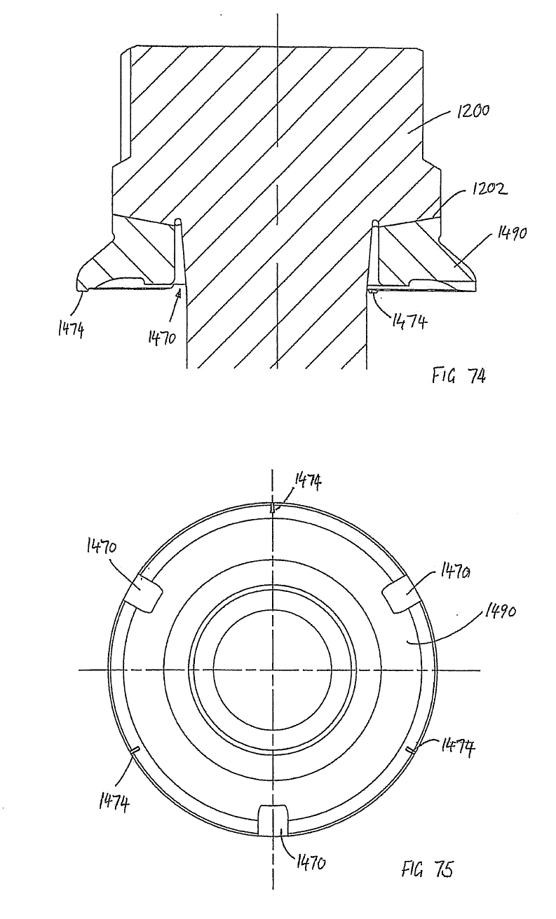

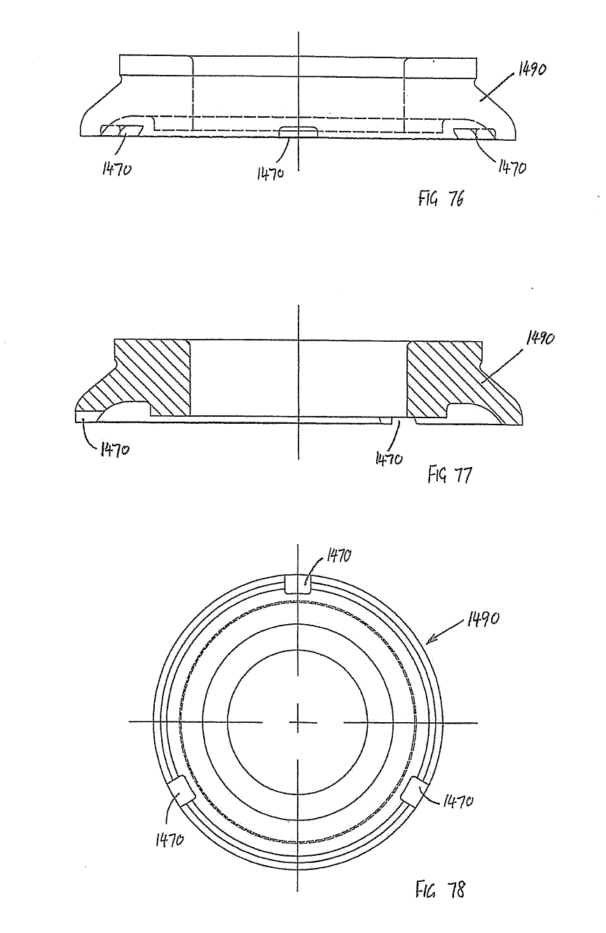

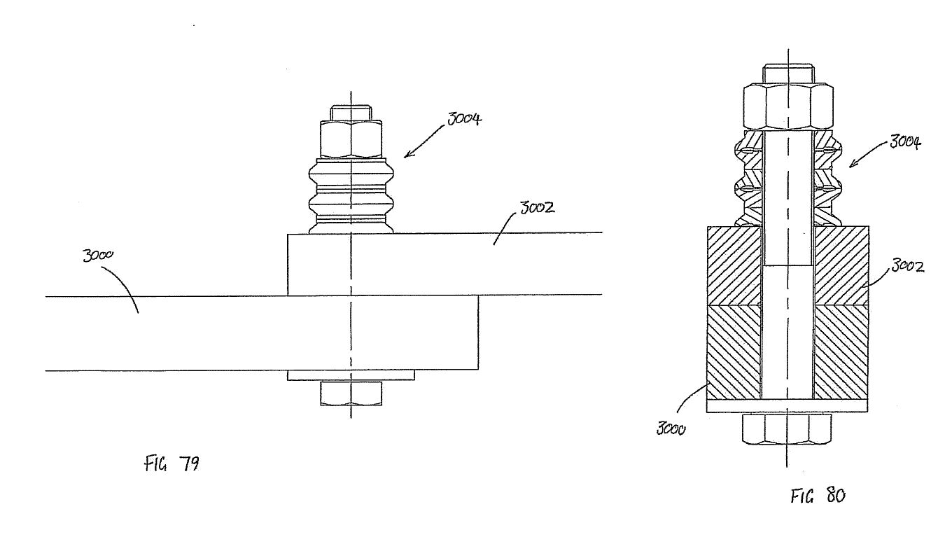

FIGS. 73 to 75 show the threaded fastener 1200 with the ratchet mechanism 1202 in engagement with the elastic element 1490.

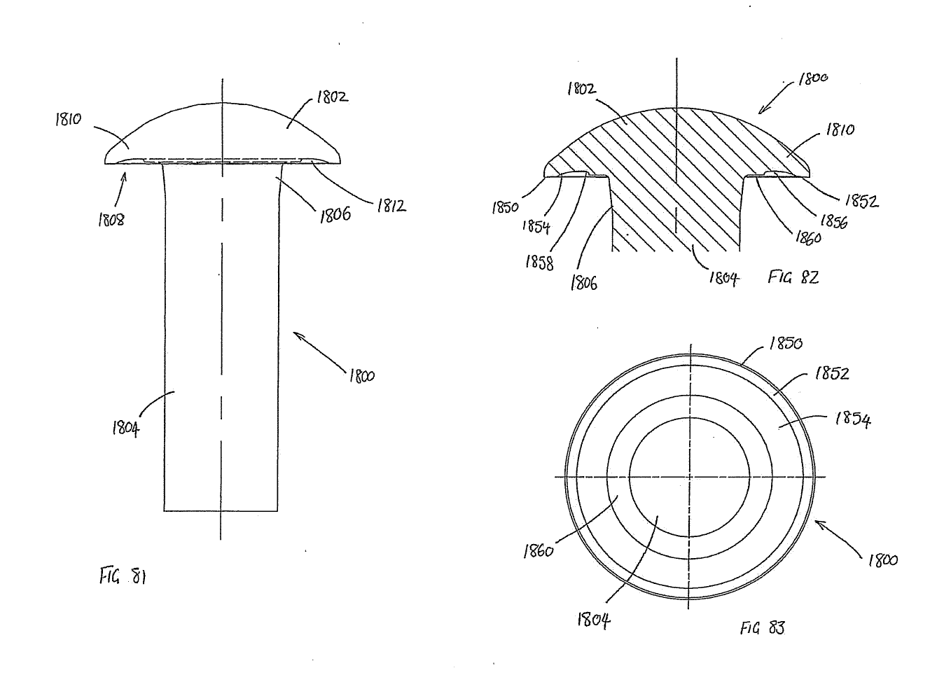

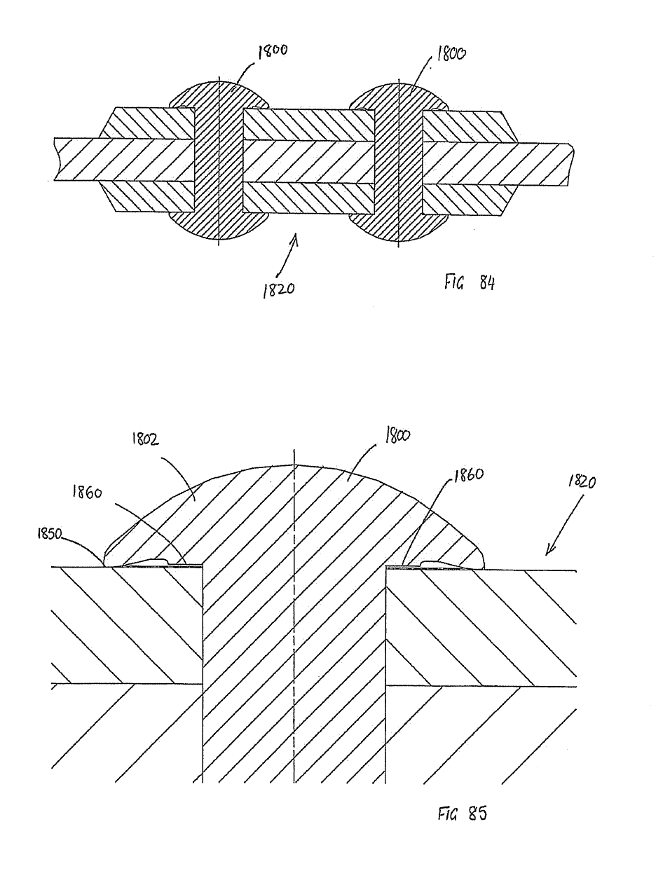

The elastic element 1490 need not have the ratchet system, the notches 1470 or the embedding protrusions 1474. FIGS. 76 to 78 show the elastic element 1490 without the ratchets or the embedding protrusions.

FIGS. 79 and 80 show two plates 3000 and 3002 coupled together by a fastener 3004 in accordance with the present invention. The fastener includes a plurality of stacked elastic washers of configuration shown in FIGS. 76 to 78, without the notches. That is, there is no ratchet engaging mechanism between the elastic washers.

A further alternative fastener in accordance with the present invention is described in relation to FIGS. 81 to 85. In this embodiment the fastener is in the form of a rivet 1800. The rivet 1800 includes a head 1802 and a shank 1804. The shank 1804 is a solid cylinder as is normal for a rivet, except that a portion near the head 1806 the shank 1804 is slightly flared out towards the head and is thus slightly conically shaped. This serves to better distribute the load on the head 1802. The head 1802 of the rivet 1800 includes an engaging surface 1808 which contacts the work-piece that the rivet 180 is fastened to. The rivet 1800 includes a curved peripheral flange portion 1810 which defines a cavity 1812 underneath. The surface 1808 is essentially the same as the profiled surface as that described in relation to FIGS. 32 to 43. It includes a peripheral contacting surface section 1850 at the rim of the flange 1810, a sloped portion 1852 of generally frusto-conical shape, a more steeply sloped and curved section 1854, a flat section 1856, a sharply curved section 1858 and a further flat section 1860, each of which make contact with the work-piece as the load progressively increases. Inwardly of the flat section 1860 is the frusto-conical portion 18 of the shank 1802. An assembled joint 1820 with rivets 1800 is shown in FIG. 84. After application of the rivet, creep will cause the surface 1860 to break contact with the surface of the work-piece. The elasticity of the curved flange portion helps to maintain compressive loading on the work-piece after creep has occurred. Furthermore if additional load is applied to the fastener during working conditions, surface 1860 may contact the fastener again sharply increasing the stiffness in the fastener, which will maintain loading to the joint. Known rivets have no resilient element therein. The rivet may be hot or cold stamped.

It is noted that the effect of creep described here will apply to the other embodiments of the invention. One of the advantages of the invention is that due to the elasticity, even at near proof load, loss of loading on the work-piece is negligible or at least at acceptable levels.

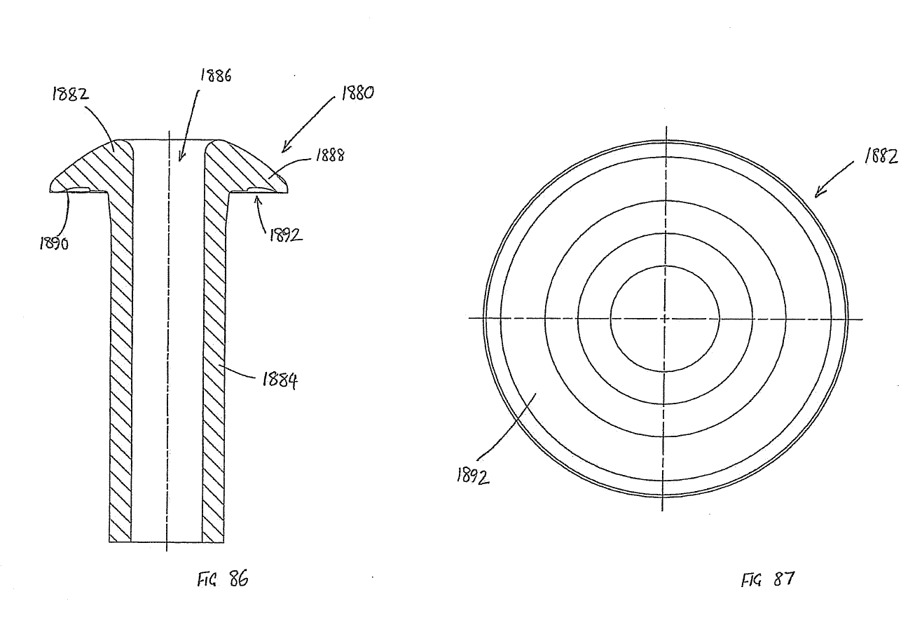

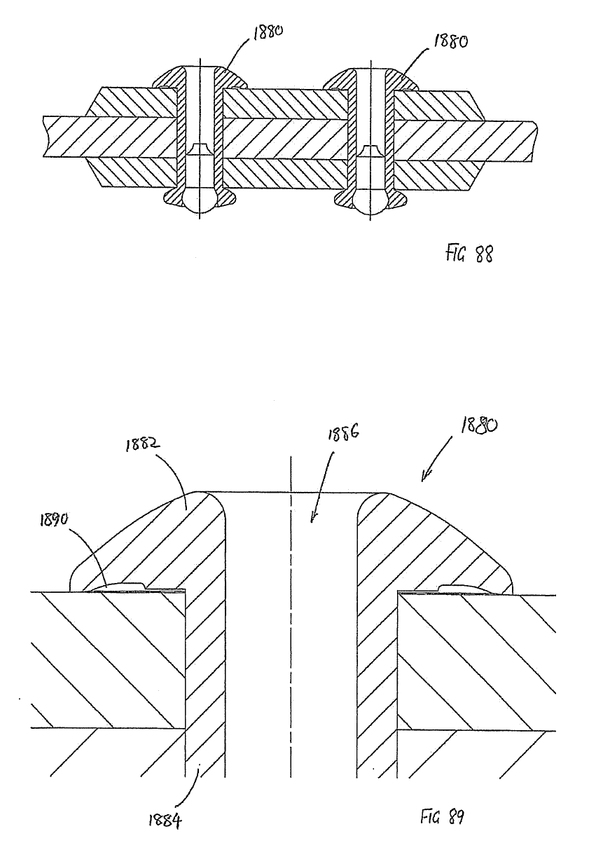

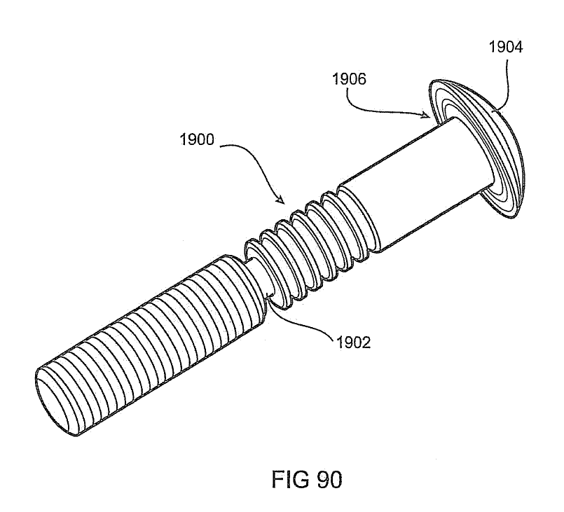

A further variation of the present invention is a pop rivet 1880 as shown in FIGS. 86 to 89. The pop rivet 1880 contains a head 1882 and a shank 1884. The head and the shank are hollow such that there is a hole 1886 extending therethrough. Pop rivet 1880 is essentially the same as a known pop rivet, except that it includes a resilient element in the form of curved flange 1888 and cavity 1890 on the under side of the head 1882 defined by a profiled contacting surface 1892 of similar configuration to the surface 1808 of the rivet 1800 described in relation to FIGS. 81 to 85.

Another variation of the present invention is shown in FIG. 90. In this example part of a snap bolt fastener 1900 is shown, where the bolt is designed to snap at narrowed section 1902 when sufficient torque is applied. In this embodiment of the invention the head 1904 includes resilient element 1906 of similar form to the resilient element of the threaded fastener in FIG. 58.

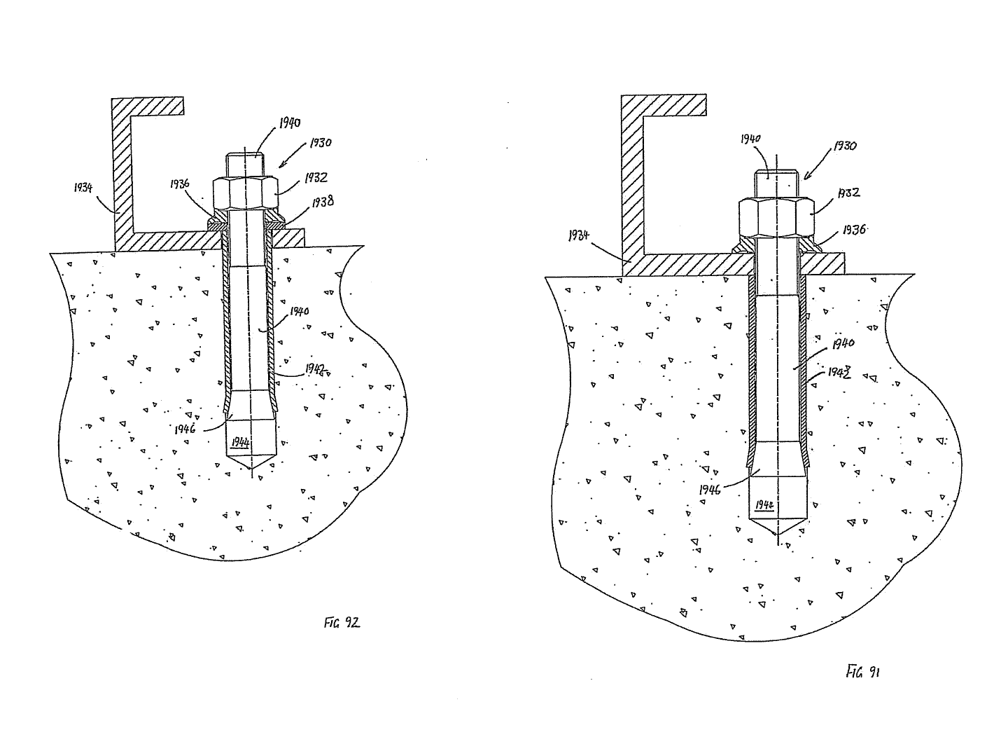

Another variation of the present invention is to include the resilient element in an expanding sleeve fastener 1930 shown in FIGS. 91 and 92 and marketed by Ramset under the trade mark DYNABOLT. Usually a flat washer is positioned between the nut 1932 of the expanding sleeve fastener and the work-piece 1934. In this embodiment of the present invention a resilient element 1936 according to various embodiment described above can replace the flat washer (shown in FIG. 91), of the washer and the nut or a resilient washer as shown in FIG. 92 can be located between the nut 1932 and the flat washer 1938.

The fastener 1930 is installed in the usual manner, that a bolt 1940 and sleeve 1942 are inserted in to a hole 1944. The nut 1932 is tightened which draws the bolt 1940 towards the nut 1932. Ahead 1946 of the bolt 1940 expands the sleeve 1942 coring the bolt 1940 and sleeve 1940 to expansively engage the hole 1940, thereby forming the joint. Inclusion of the resilient element is useful to absorb variations in the load after the expanding sleeve fastener is installed. Such expanding sleeve fasteners are often installed in construction sites which may be subject to great temperature fluctuations and/or dynamic load variations or loading variations due to severe weather conditions or geological events such as tremors and earthquakes.

From the foregoing, it is evident that the various embodiments provide a simple yet highly effective fastener. In some embodiments the fastener is a threaded fastener assembly which can be readily assembled and disassembled, and which can resist vibration and dynamic loads, as well as thermal variations. A particular feature of the threaded fastener assembly providing such characteristics is the use of the elastic element as a washer or by incorporation into a through hole fastener element, for example a bolt or rivet. The elastic washer may be in facing engagement with another fastener element (nut or bolt) through a ratchet mechanism, as described. The ratchet mechanism in conjunction with the elasticity of the elastic element serves to function as a clutch, allowing rotation of the fastener element in the tightening direction and inhibiting rotation in the unscrewing direction.

In other embodiments the fastener assembly includes a compressible elastic element of greater elasticity than a shaft shank of the fastener assembly.

While the embodiments have been described with reference to the elastic element forming part of the particular fastener assemblies described and illustrated, it should be understood that the elastic element itself may also have applications in other fastener assemblies.

Modifications and variations may be made to the present invention without departing from the basic inventive concept. Such modifications and variations are intended to fall within the scope of the present invention which is to be determined from the foregoing description and dependent claims.

1. A fastener assembly comprising a washer and a fastening element, the fastening element having an abutting face for transferring force to the washer, the fastening element having a periphery about the abutting face, the periphery being angled relative to the abutting face on the fastening element, the washer having a first face for contact with the fastening element, the first face having an inner portion for contact with the abutting face and a sloped outer portion about the inner portion, wherein the sloped outer portion is arranged to engage with the periphery of the fastening element.

2. A fastener assembly as claimed in claim 1, wherein the periphery is chamfered around the abutting face.

3. A fastener assembly as claimed in claim 1, wherein the inner portion of the first face of the washer is annular.

4. A fastener assembly as claimed in claim 1, wherein the inner portion of the first face of the washer is flat.

5. A fastener assembly as claimed in claim 1, wherein the fastening element is an internally threaded fastener.

6. A fastener assembly as claimed in claim 1, wherein the fastening element is an externally threaded fastener having a head portion.

7. A fastener assembly as claimed in claim 6, wherein the fastening element is a bolt.

8. A fastener assembly as claimed in claim 1, wherein the sloped outer portion of the first face of the washer comprises a plurality of ramps forming a circular ratchet structure around the inner portion for resisting rotation in an unscrewing direction, while allowing rotation in a tightening direction.

9. A fastener assembly as claimed in claim 1, wherein the first face of the washer includes a groove separating the inner portion from the sloped outer portion.

10. A fastener assembly as claimed in claim 1, wherein the washer is elastically deformable.

11. A fastener assembly as claimed in claim 10, wherein the stiffness of the washer increases with load.

12. A fastener assembly as claimed in claim 11, wherein the washer has a second face opposed to the first face, the second face having a first loading surface and a second loading surface, the first and second loading surfaces being separated by a recess, whereby the washer is arranged to transfer load only through the first loading surface when loaded up to a first loading limit, and is arranged to transfer load through both first and second loading surfaces beyond the first loading limit.

13. A fastener assembly as claimed in claim 1, wherein the washer has a body including an inner portion extending between the inner portion of the first face and an inner portion of a second face opposed to the first face, and where the inner portion of the body provides central stiffness to the washer.

14. A washer for use in a fastener assembly, the fastener assembly comprising the washer and a fastening element, the fastening element having an abutting face for transferring force to the washer, the fastening element having a periphery about the abutting face, the periphery being angled relative to the abutting face of the fastening element, wherein the washer has a first face for contact with the fastening element, the first face having an inner portion for contact with the abutting face and a sloped outer portion about the inner portion, the sloped outer portion being arranged to engage with the periphery of the fastening element.

15. A washer as claimed in claim 14, wherein the inner portion of the first face of the washer is annular.

16. A washer as claimed in claim 14, wherein the inner portion of the first face of the washer is flat.

17. A washer as claimed in claim 14, wherein the sloped outer portion of the first face of the washer comprises a plurality of ramps forming a circular ratchet structure around the inner portion for resisting rotation in an unscrewing direction, while allowing rotation in a tightening direction.

18. A washer as claimed in claim 14, wherein the first face of the washer includes a groove separating the inner portion from the sloped outer portion.

19. A washer as claimed in claim 14, wherein the washer is elastically deformable.

20. A washer as claimed in claim 19, wherein the stiffness of the washer increases with load.

21. A washer as claimed in claim 20, wherein the washer has a second face opposed to the first face, the second face having a first loading surface and a second loading surface, the first and second loading surfaces being separated by a recess, whereby the washer is arranged to transfer load only through the first loading surface when loaded up to a first loading limit, and is arranged to transfer load through both first and second loading surfaces beyond the first loading limit.

22. A washer as claimed in claim 14, wherein the washer has a body including an inner portion aligned with the inner portion of the first face, and where the inner portion of the body provides stiffness to the washer.

23. A fastener assembly comprising a fastening element and a washer, the fastening element having an internally threaded bore, the fastening element having a head portion and projection portion arranged axially along the bore, the head portion being larger in a radial direction than the projection portion, the washer having a force transferring portion, the force transferring portion having an internal radius greater than the external radius of the projection portion, the force transferring portion being arranged to locate around the projection portion, such that axial compressive forces acting through the washer are transmitted to the head portion and distributed along the internally threaded bore at least partially within the head portion and the projection portion.

24. A fastener assembly as claimed in claim 23, wherein the projection portion has an outer radial periphery surface which tapers inwardly towards a free end of the projection portion.

25. A fastener assembly as claimed in claim 24, wherein the washer has a frusto-conical internal surface arranged to be spaced from the outer radial periphery surface of the projection portion in a clearance fit.

26. A fastener assembly as claimed in claim 23, wherein the force transferring portion of the washer has a first engaging face arranged to engage with an engaging face of the head portion, the engaging faces having a mechanical connection for coupling together when the fastener assembly is rotated in a tightening direction.

27. A fastener assembly as claimed in claim 26, wherein the mechanical connection couples the engaging faces together when the fastener assembly is rotated in an unscrewing direction.

28. A fastener assembly as claimed in claim 27, wherein the mechanical connection is provided by inter-engaging grooves.

29. A fastener assembly as claimed in claim 26, wherein the mechanical connection disengages the engaging faces in response to rotation of the fastening element relative to the washer in an unscrewing direction.

30. A fastener assembly as claimed in claim 29, wherein the mechanical connection comprises a ratchet structure on each of the engaging faces.

31. A fastener assembly as claimed in claim 26, wherein the engaging faces of the fastener assembly are sloped to promote centering.

32. A fastener assembly as claimed in claim 31, wherein the engaging faces are sloped by between 10 and 15 degrees.

33. A fastener assembly as claimed in claim 23, wherein the washer is elastically deformable.

34. A fastener assembly as claimed in claim 33, wherein the stiffness of the washer increases with load.

35. A fastener assembly as claimed in claim 34, wherein the washer has a second face spaced from the head portion of the fastening element, the second face having a first loading surface and a second loading surface, the first and second loading surfaces being separated by a recess, whereby the washer is arranged to transfer load only through the first loading surface when loaded up to a preliminary loading limit, and is arranged to transfer load through both first and second loading surfaces beyond the preliminary loading limit.

36. A fastener assembly as claimed in claim 23, wherein the force transferring portion of the washer provides stiffness to the washer when the washer is under load.

37. A fastening element in a fastener assembly as claimed in claim 23.

38. A fastener assembly comprising a first fastening element, a second fastening element and a washer, the first fastening element having an internally threaded bore, the first fastening element having a head portion and projection portion arranged axially along the bore, the head portion being larger in a radial direction than the projection portion, the second fastening element having a force transferring portion, the force transferring portion having an internal radius greater than the external radius of the projection portion, the force transferring portion being arranged to locate about the projection portion, such that axial compressive forces acting through the washer are transmitted through the second fastening element to the head portion and distributed along the internally threaded bore at least partially within the head portion and the projection portion.

39. A fastener assembly as claimed in claim 38, wherein the projection portion has an outer radial periphery surface which tapers inwardly towards a free end of the projection portion.

40. A fastener assembly as claimed in claim 39, wherein the second fastening element has a frusto-conical internal surface arranged to be spaced from the outer radial periphery surface of the projection portion in a clearance fit.

41. A fastener assembly as claimed in claim 38, wherein the force transferring portion of the second fastening element has a first engaging face arranged to engage with an engaging face of the head portion, the engaging faces having a mechanical connection for coupling together when the fastener assembly is rotated in a tightening direction.

42. A fastener assembly as claimed in claim 41, wherein the mechanical connection couples the engaging faces together when the fastener assembly is rotated in an unscrewing direction.

43. A fastener assembly as claimed in claim 42, wherein the mechanical connection is provided by inter-engaging grooves.

44. A fastener assembly as claimed in claim 41, wherein the mechanical connection urges the engaging faces apart in response to rotation of the fastening element relative to the washer in an unscrewing direction.

45. A fastener assembly as claimed in claim 44, wherein the mechanical connection comprises a ramp structure on each of the engaging faces.

46. A fastener assembly as claimed in claim 38, wherein the engaging faces of the fastener assembly are sloped to promote centering.

47. A fastener assembly as claimed in claim 46, wherein the engaging faces are sloped by between 10 and 15 degrees.

48. A fastener assembly as claimed in claim 38, wherein the washer is elastically deflectable.

49. A fastener assembly as claimed in claim 48, wherein the stiffness of the washer increases with load.

50. A fastener assembly as claimed in claim 49, wherein the washer has a second face spaced from the second fastening element, the second face having a first loading surface and a second loading surface, the first and second loading surfaces begin separated by a recess, whereby the washer is arranged to transfer load only through the first loading surface when loaded up to a preliminary loading limit, and is arranged to transfer load through both first and second loading surfaces beyond the preliminary loading limit.

51. A fastener assembly as claimed in claim 38, wherein the washer has a body including an inner portion aligned with the force transferring portion of the second fastening element, and where the inner portion of the body provides stiffness to the washer when the washer is under load.

52. A fastener assembly as claimed in claim 38, wherein the washer includes a plurality of ramps forming a circular ratchet structure about an annular surface oriented away from the second fastener element.

53. A fastener assembly as claimed in claim 38, wherein the second fastener element is formed from a material harder than that of the first fastener element.

54. A fastening element in a fastening assembly as claimed in claim 38.
